(19) United States
(12) Patent Application Publication
(10) Pub. No.: US 2026/0056721 A1
(43) Pub. Date: Feb. 26, 2026

(54) LOW-LEVEL MEMORY MANAGEMENT OF COMPUTED ENTITIES

(71) Applicant: Zoho Corporation Private Limited, Kanchipuram District (IN)

(72) Inventors: Saroja Parameswaran, Chengalpattu Taluk (IN); Vasanthan N, Poonamallee (IN); Akshhayaa S, Guduvanchery (IN); Sridhar Vembu, Tenkasi (IN)

(73) Assignee: Zoho Corporation Private Limited, Kanchipuram District (IN)

(21) Appl. No.: 19/260,489

(22) Filed: Jul. 5, 2025

Related U.S. Application Data
(60) Provisional application No. 63/683,833, filed on Aug. 16, 2024.

(30) Foreign Application Priority Data
Jul. 5, 2024 (IN) 202441051724

(51) Int. Cl. G06F 8/41

(52) U.S. Cl. CPC G06F 8/41

(57) ABSTRACT

A compiler comprises a low-level memory management (LLMM) module that locates computed entities within source code. Each computed entity is analyzed, and resource costs associated with each computed entity are calculated. A memory model is selected for each computed entity, based on memory use, computational complexity, and other factors. User-defined memory model assignment is supported. The compiler auto-generates instructions for allocating memory for, computing, and deallocating memory for each computed entity. The instructions generated for each computed entity will vary based on its assigned memory model. A variety of embodiments are disclosed for auto-generating these instructions during compile time at differing phases of compilation. In all of those, with the resultant executable code, memory is allocated and freed at runtime automatically and accurately without the intervention in source code by a programmer.

### CROSS REFERENCE TO RELATED APPLICATION

This application is related to Indian Provisional Application 20/244,1051724 filed 5 Jul. 2024, and U.S. Provisional Application 63/683,833 filed 16 Aug. 2024, both entitled “LOW-LEVEL MEMORY MANAGEMENT OF COMPUTED ENTITIES”, both incorporated herein by reference.

### FIELD OF THE INVENTION

Embodiments of the present disclosure are related, in general, to computer programming languages and more particularly, but not exclusively, to memory management of computed entities within data objects.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1A depicts an example embodiment of a computational device 100 which comprises a compiler 130 operable with an Intermediate Representation (IR) 140 of source code 110 to perform memory management for computed entities.

FIG. 1B illustrates executable code 160 loaded into a memory 150 of computational device 100 to perform data object management and computed entity memory allocation and deallocation at runtime.

FIG. 1C illustrates alternate embodiments of generating Low-level Memory Management (LLMM) code for computed entity memory management in computational device 100.

FIGS. 2A-D include a flowchart 200 illustrating a method of low-level memory management for computed entities.

FIG. 3 is a flowchart 300 illustrating example factors that can be used in memory model selection by LLMM 120.

FIG. 4 illustrates an example architecture of a Low-Level Memory Management (LLMM) module 120.

FIG. 5 is a flowchart 500 illustrating computing and selecting memory models for computed entities.

FIG. 6A is an example compiler 130 with a flowchart 600 illustrating LLMM processing on an intermediate representation.

FIG. 6B is an example compiler 130 with flowchart 600 modified to illustrate LLMM stitching parse tree equivalent event handlers to an AST during semantic analysis and adding calls during code generation.

FIG. 6C is an example compiler 130 with flowchart 600 modified to illustrate stitching source code event handlers and associated calls to source code 110 during semantic analysis.

FIGS. 7A-D illustrate inserted calls into a graphical representation of a sample abstract syntax tree 180, varying based on selected memory model.

FIGS. 8A-D show example executable code 160 for each of the three memory models, and an alternate embodiment.

FIGS. 9A-D show graphical representations of memory usage and computational resource used for comparing aspects of each model.

FIG. 10 is an alternate flowchart 200 illustrating a method of low-level memory management for computed entities supporting user assigned memory models.

FIG. 11 illustrates a construct for supporting user assigned memory models.

FIG. 12 illustrates an example embodiment of distributed Integrated Development Environment (IDE) 1200 including components of a computational device, or user terminal, 100.

### DETAILED DESCRIPTION

A construct in a programming language refers to a particular syntactic structure or a piece of code that performs a specific task. Constructs are the basic building blocks of a program, and they can include various elements such as data types (integers, strings, etc., as well as user-defined), variables, operators, control structures (if statements, for loops, while loops, etc.), functions and procedures, classes and objects, modules and packages, and exception handling constructs. A construct may be comprised of multiple constructs, such as a block of code. Each programming language has its own set of constructs, and the way these constructs are used can vary from one language to another.

At the source code level, user-defined types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units. At compile time, the compiler checks these types for syntactic and semantic correctness. This includes ensuring that the members of a class or structure are correctly defined, that methods are properly declared and implemented, and that any inheritance or interface implementation is correctly specified.

Once the source code is compiled and becomes an executable, the user-defined types are transformed into machine code, ready for execution. At runtime, when these types are instantiated, memory is allocated for the resulting objects. For languages with manual memory management like C++, the developer allocates memory for objects using constructs like ‘new’ and releases memory with ‘delete’. In contrast, languages with garbage collection, such as Java or C #, handle memory deallocation automatically once objects are no longer reachable. The runtime environment is responsible for managing the object lifecycle, ensuring that constructors are called when an object is created, and destructors (if applicable) are called when an object is destroyed. The management of these objects and the execution of associated methods form the core of runtime object management based on user-defined types. Automatic memory allocation and deallocation techniques for managing objects often have the benefit of case of use by developers but may not be as memory efficient or computationally efficient as manual memory management. It is desirable to have a compiler that facilitates case of use by developers as well as efficient memory management.

A programming language provides for user defined data types, which, when compiled, produce instructions for the use of data objects of the defined data type. Types are defined for use in instantiating objects at runtime. Objects can be affected by object management instructions compiled from object management constructs. Examples of object management constructs include create, update, and delete. A type comprises one or more elements and may include computed entities and user-created entities.

The term Computed Entity (CE) defines a type or entity of a type that is dependent on an Independent Entity (IE), which may be a user-creatable entity. A computed entity can also be derived from additional independent entities as well as from another computed entity. A computed entity can be a single variable or a collection such as a set or a sequence. The independent entity can also be a scalar or a collection. When an independent entity is updated, then prior to use, a computed entity depending on that independent entity should be updated accordingly. Updating a scalar CE entails recomputing its value, while updating a collection may include adding a new element, recomputing one or more element values, or deleting an element from the collection.

From a programmer's perspective, objects are defined in source code based on a defined type with an independent entity and a computed entity based on that independent entity, and those objects can be created, accessed, updated, and deleted in other statements in source code. It may be the perception that executable code compiled from that source code will result in objects being instantiated in memory with all their respective elements, including computed entities, and the computed entities are kept up to date by recomputing whenever an independent entity on which they depend is updated. As such, at one level of abstraction, these objects exist and remain accessible at runtime from creation to deletion. However, this may not be the most efficient use of physical memory and compute resource at runtime.

Specifically, it may be efficient to decouple the creation of a computed entity from the creation of its independent entity and, rather, creating the computed entity on demand. This allows memory that would otherwise remain allocated to a computed entity to be free for other uses. This is particularly useful for infrequently used but high memory usage computed entities. Updating, or recomputing, of computed entities can also be deferred to an actual access, which can be computationally efficient if multiple updates to the independent entity are occurring, but access to the dependent computed entity occurs at a lower frequency. A computed entity, after having been accessed for a period of time, may be deleted and have its memory deallocated and returned for use by other processes. Alternatively, having been created, the computed entity may be retained and kept available until its independent entity is deleted, to avoid having to reallocate and recompute.

In embodiments detailed below, a compiler comprises a Low-Level Memory Management (LLMM) module that locates computed entities within source code. Each computed entity is analyzed as it relates to other constructs within the source code, and resource costs associated with each computed entity are calculated. Based on resource costs and other system settings, a memory model for each computed entity is selected.

A memory model for a computed entity may be designed to be sensitive to its memory use, its computational complexity, and other factors including but not restricted to the application requirements and system configuration. The compiler automatically manages memory allocation for computation of computed entities to gain efficiencies, while maintaining the abstraction of always-available computed entities from the programmer's point of view.

The compiler auto-generates instructions for allocating memory for, computing, and deallocating memory for each computed entity. The instructions generated for each computed entity will vary based on its assigned memory model. A variety of embodiments are disclosed for auto-generating these instructions during compile time at differing phases of compilation. In all of those, however, with the resultant executable code, at runtime, memory is allocated and freed automatically and accurately without the intervention in source code by a programmer.

The analysis done to identify the memory model for the computed entity is based on certain identified set of parameters that affect the computed entities. The parameters can be categorized into system parameters and user-defined parameters. System parameters include the processor's configuration for determining the total available memory, access time, cycle time, block size and bandwidth. User-defined parameters are obtained from a user that includes the size of the dataset (or data) involved in computing the computed entity, the level of the complexity of the query or calculation involved to determine the computed entity, and the frequency and proximity of access of the computed entity. The dataset associated with the user-creatable or independent entity is one key factor that determines the memory space required for a collection computed entity such as a set or sequence. The number of filters applied, or queries, involved in computing the computed entity affects the level of computation complexity for the computed entity.

Based on the values of the set of parameters and their preferred order of occurrence (setting the priority level of the parameters, if any), the compiler correlates the parameters with respect to key factors such as cost of computation and cost of memory. Memory indicates the memory space required for the computed entity and is related to the size of the dataset. The cost of computation indicates the level of computation for the computed entity.

As an outcome of the analysis, the compiler selects a memory model from the variations of memory models. Based on the selected model, the compiler auto-generates the instructions for memory allocation and deallocation of computed entities at compile-time. In addition, the compiler auto-generates instructions for computation or updating a computed entity which may differ according to the memory model selected. At runtime, the auto-generated instructions are executed, which results in memory allocation, memory deallocation, and computing of the computed entities.

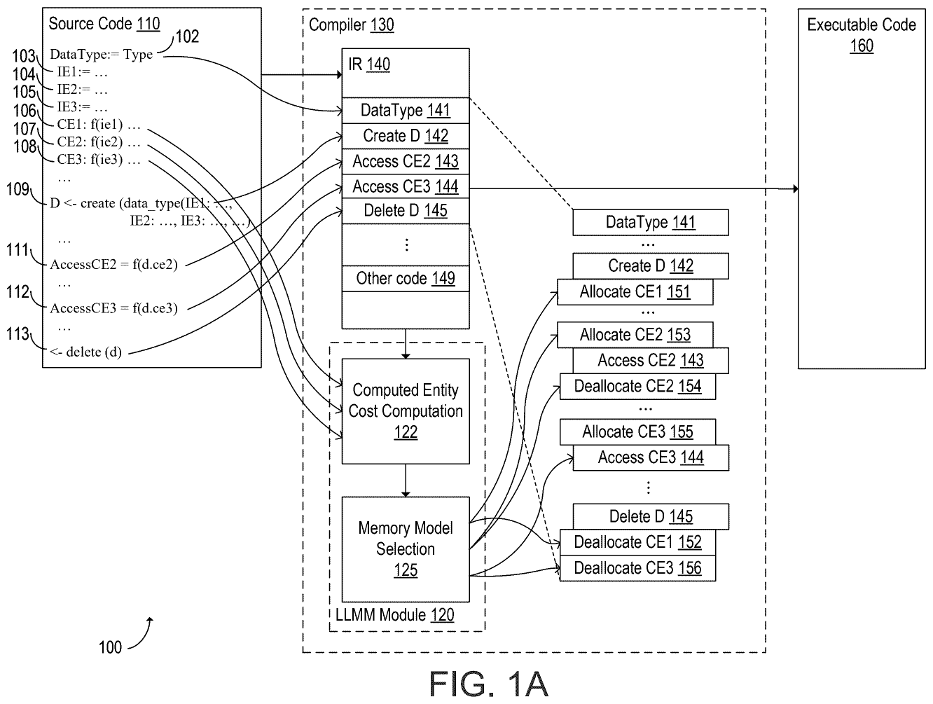

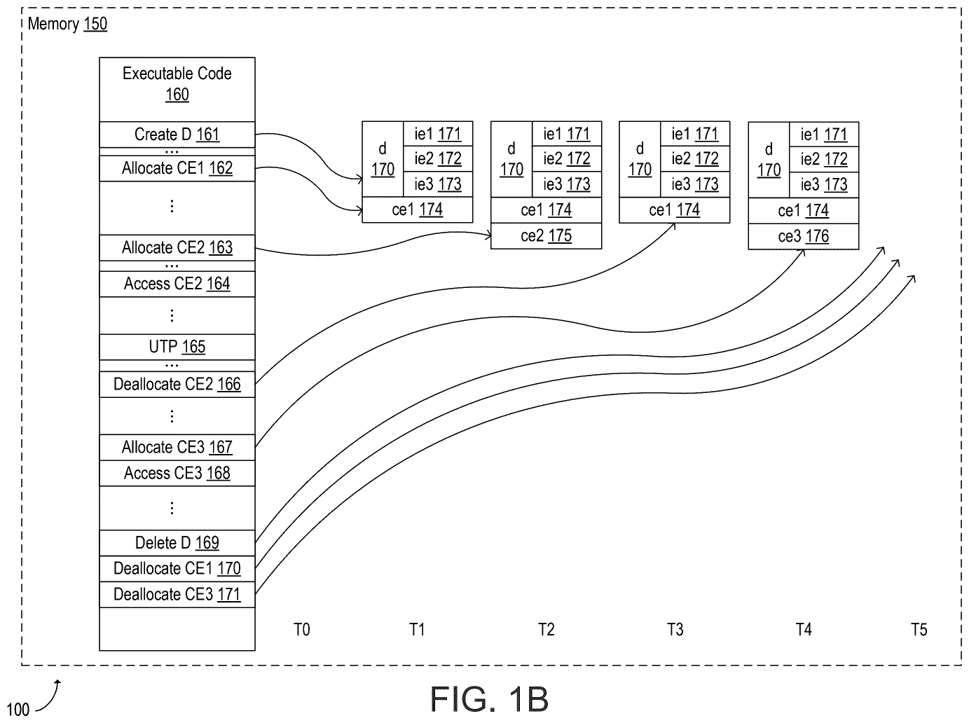

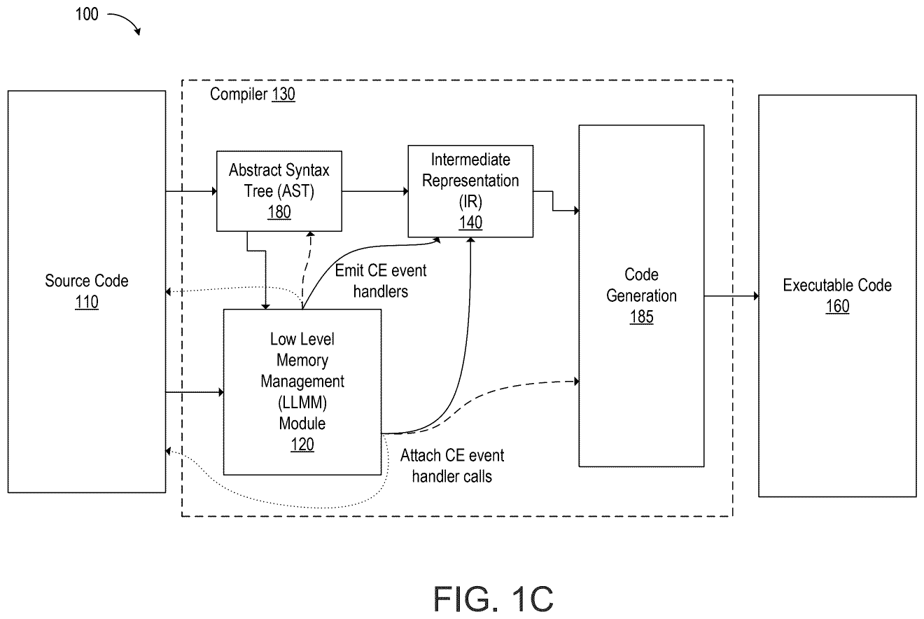

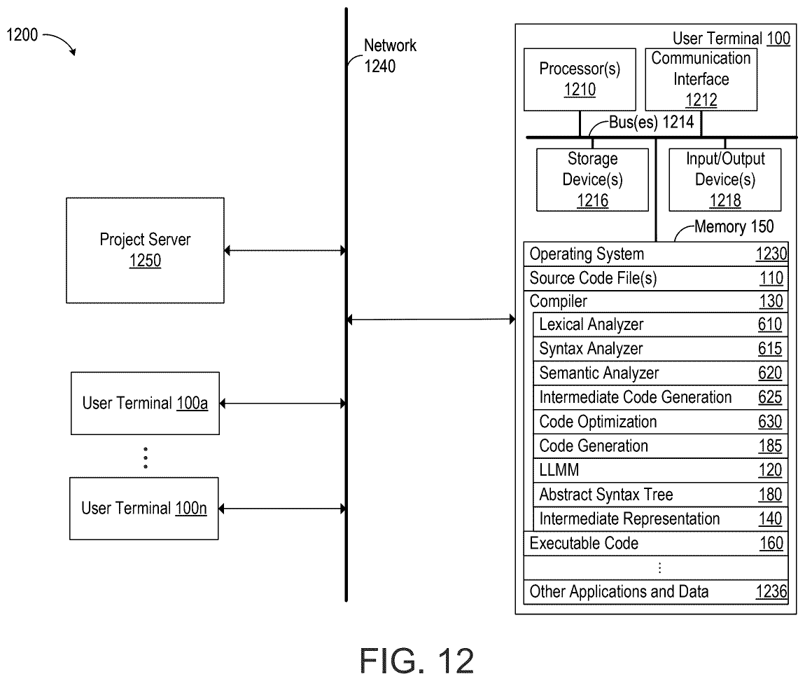

FIG. 1A depicts an example embodiment of a computational device 100, such as a computer or user terminal, detailed further below with respect to FIG. 12, which comprises a compiler 130 operable with an Intermediate Representation (IR) 140 of source code 110 to perform memory management for computed entities. IR 140 can be further compiled to produce executable code 160. FIG. 1B illustrates executable code 160 loaded into a memory 150 of computational device 100 to perform data object management and computed entity memory allocation and deallocation at runtime.

Compiler 130 generates Intermediate Representation (IR) 140 from source code 110. Low Level Memory Management (LLMM) module 120 operates on IR 140, which can be any type of IR, including but not limited to an Abstract Syntax Tree (AST), and can operate on source code directly in an alternate embodiment. It identifies each computed entity in source code. For each computed entity a cost is computed using computed-entity cost-computation module 122. Responsive to the computed cost, one of a plurality of memory models is selected for each computed entity using memory model selection module 125. LLMM 120 generates instructions to allocate and deallocate memory for and to compute each computed entity and inserts those instructions into IR 140 in varying manner responsive to the memory model selected for the computed entity. Any number of additional compiling phases may be performed on IR 140, and IR 140 may be compiled into executable code 160.

Source code 110 comprises a data type 102 for defining a data object of type DataType. It includes independent entities IE1 103, IE2 104, and IE3 105. Computed entities CE1 106, CE2 107, and CE3 108 are defined which are computed using independent entities 103-105, respectively. In this illustration, the independent and computed entities belong to the same type. Computed entities in a first type dependent on independent entities from a second type are also supported. Create statement 109 creates object D of type DataType. Create statement 109 is also a create statement for instantiating independent entities IE1-IE3 103-105. DataType definition 102 is compiled into IR instructions 141. IR create instructions Create D 142 are generated from the create statement 109. Note that separate create statements for an independent entity may be provided in a programming language such that independent entities of an object are instantiated at different times than the object itself, and creation of independent entities may be optional or conditional, in any given language.

Source code 110 also comprises an access statement 111 for accessing computed entity CE2 from which IR instructions Access CE2 143 are generated, and an access statement 112 for accessing computed entity CE3 from which IR instructions Access CE3 144 are generated. Delete statement 113 deletes object D. It is also a delete statement for deleting independent entities IE1-IE3 103-105. IR instructions Delete D 145 are generated from delete statement 113. All other source code 110 statements (details not shown) are generated into IR code illustrated as Other code 149. All source code statements can be evaluated and analyzed for performing computed entity cost computation (122) and memory model selection (125).

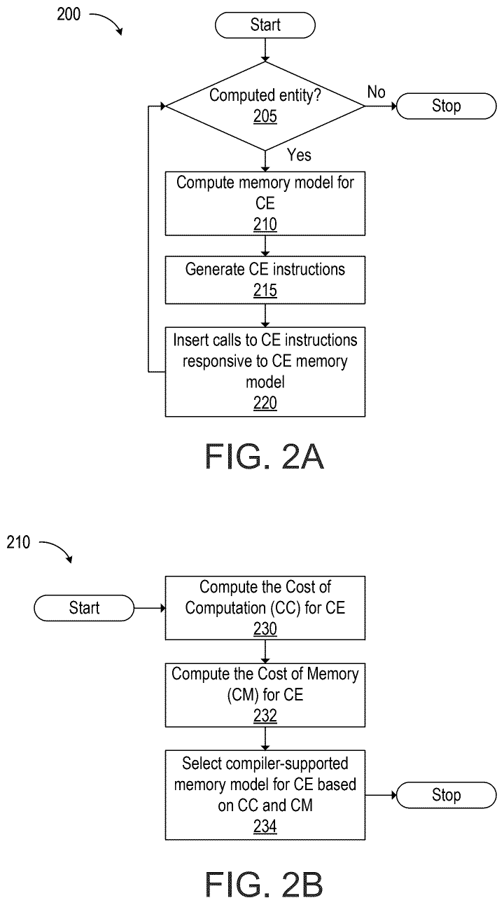

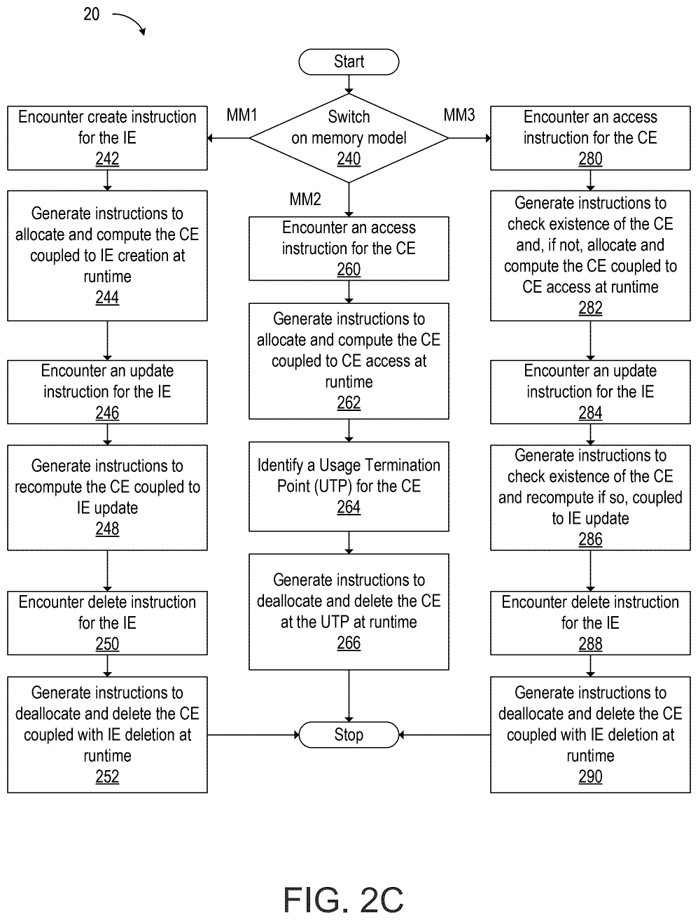

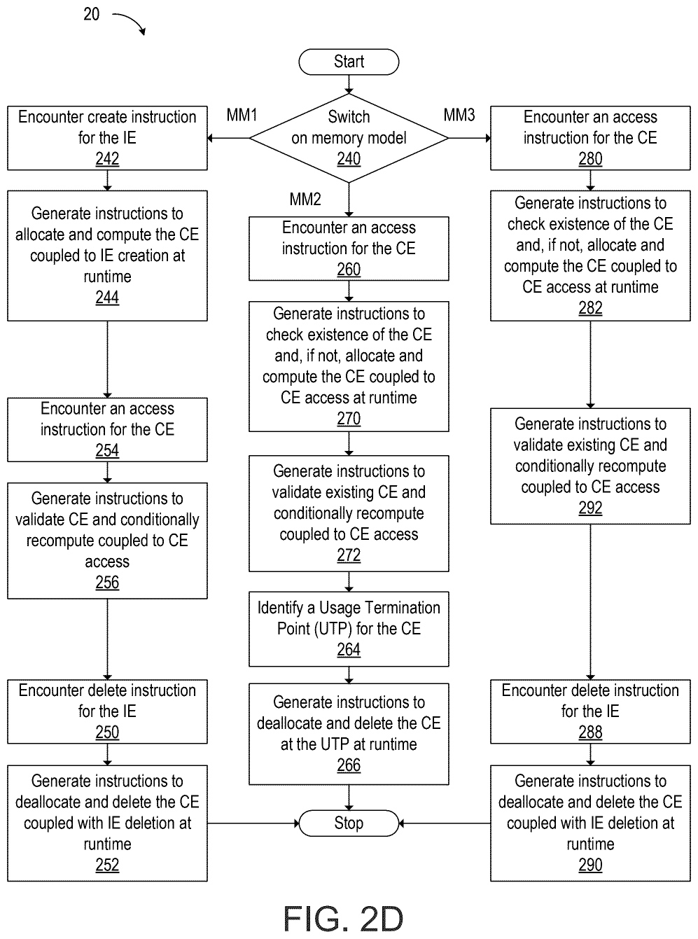

FIGS. 2A-D include a flowchart 200 illustrating a method of low-level memory management for computed entities. In FIG. 2A, for each computed entity located in source code (205), a memory model is computed (210). Instructions to allocate and deallocate memory for and compute each computed entity are generated (215) and included in the code being compiled. Additional instructions may be generated, such as those checking for existence of objects, maintaining time stamps, verifying a computed entity is up to date, and various other instructions useful in varying embodiments. Calls to those instructions determine when the memory required for a computed entity is allocated, when the computed entity is computed or recomputed, and when the computed entity memory should be deallocated. Those calls are inserted at locations in the compiled code responsive to the memory model selected (220)

FIG. 2B is flowchart illustrating an example embodiment of computing a memory model for a computed entity (210). In general, a cost is computed for the computed entity, and a memory model is selected responsive to the computed cost. In this example, on encountering a computed entity that is computed using an independent entity, the compiler calculates the Cost of Computation (CC) of the computed entity (230). This may depend on a variety of factors such as the number of filters used to compute the computed entity, the complexity of calculation involved in its calculation and others. Then, the Cost of Memory (CM) for the computed entity is calculated (232). The size of the computed entity may be known from source code or at least hinted at. Examples are detailed further below. In some cases, the memory size may not be known at all during compilation, and that is a valid result for CM computation. Various embodiments may be deployed to specify how model selection for unknown memory-sized computed entities is performed, and examples are shown below. Based on the cost of computation (CC) and memory (CM) an appropriate memory model is assigned to the computed entity by the compiler (234). In one embodiment, the memory model is fetched directly from a mapping table. For cases where there is no direct mapping (e.g. memory size is unknown), the compiler decides based on other parameters affecting the resources required of the computed entity.

When generating computed entity instructions (215), the compiler will encounter in a program representation one or more statements with instructions affecting a computed entity and one or more statements with instructions affecting the independent entity used by the computed entity. It will generate CE instructions that compile to runtime instructions for affecting the computed entity and IE instructions that compile to runtime instructions for affecting the independent entity accordingly. It will insert the CE and IE instructions in the program representation in a manner corresponding to the memory model computed for the CE (220). The manner of insertion may include using calls to the instructions at differing locations within the program representation (examples detailed below), but other compilation methods may also be used.

Examples of statements affecting computed and independent entities include create statements, update statements, access statements, and delete statements. Generated instructions for each of these may include memory allocation, object instantiation, entity computation, memory deallocation, and others. Instructions may include checking the existence of an entity or validating whether entity is in an updated state. The manner in which instructions are generated and inserted includes either coupling or decoupling an effect to the computed entity from an effect to the independent entity. When the computed and independent instructions are decoupled, the computed entity instructions may be coupled to another event, such as an access. In some cases, the coupling is conditional, e.g. based on the existence of an entity,

FIG. 2C is a flowchart 20 illustrating a general embodiment of generating CE instructions and how to call those instructions in various scenarios, based on three example memory models. This flowchart is one example illustrating generating CE instructions 215 and inserting calls responsive to selected memory model 220. The three example memory models illustrate various aspects. Other sets of memory models with different selected aspects will be deployed in alternate embodiments.

The process for compiling the CE instructions for an encountered computed entity begins by switching (240) on selected memory model. The choices illustrated are MM1 for Memory Model 1, MM2 for memory model 2, and MM3 for Memory Model 3. A computed entity may be created essentially simultaneously after the creation of the independent entity (e.g. coupled) or can be deferred until another event, such as when it is accessed (e.g. decoupled). Similarly, an update or re-computation of a computed entity can be coupled or decoupled with an update to the independent entity. Deletion and deallocation of a computed entity may be either coupled or decoupled with deletion of an independent entity.

In this embodiment, MM1 couples all three. This approach keeps the computed entity available in memory and updated for access whenever needed. A create instruction for the IE is encountered in a statement (242). In response, the compiler generates instructions to create the computed entity (e.g. allocate memory for and compute) and inserts them into the program representation such that, once compiled, are executed at runtime in a sequence subsequent to and coupled with the creation of the IE (244). When an update instruction for the IE is encountered (246), then generate instructions to recompute the computed entity coupled to the IE update (248). The generated instructions are inserted into the program representation such that instructions compiled from them are executed in a sequence subsequent to and coupled with instructions compiled from the IE update instruction at runtime. Similarly, when a delete instruction for the IE is encountered (250), then generate instructions to delete the computed entity coupled to the IE delete (252). The generated instructions are inserted into the program representation such that instructions compiled from them are executed in a sequence subsequent to and coupled with instructions compiled from the IE delete instruction at runtime.

MM2 and MM3 decouple creation of the computed entity from creation of the independent entity. Instead, the computed entity is created responsive to an access to it. In both models, updates to the IE don't trigger updates to the CE prior to their creation (subsequent to first access). The models differ in that MM2 decouples delete of CE from delete of IE, while MM3 couples it. In MM3, the CE is deleted coupled with the deletion of the IE and remains in memory until then. In MM2, the CE is maintained until its usage is not required based on a various metrics, detailed further below. Then the CE is deleted. The MM2 CE may be created and deleted any number of times during the life cycle of its IE.

In one embodiment, updates to the CE may be coupled with updates to the IE. This was described for MM1 above. For MM2, updates to the IE may trigger an update to the CE when it exists. In one embodiment, a design constraint prevents updates to the IE while the CE is in existence. In another embodiment, updates to the IE are allowed and are coupled with CE updates. For MM3, updates are coupled for IE and CE once the CE is created, until the coupled delete of the IE and CE occurs.

For MM2, when an access instruction is encountered for the CE (260), generate instructions to allocate and compute the CE coupled to the CE access at runtime (262). This is decoupled from IE instructions. A Usage Termination Point (UTP) is determined (264) at which instructions in the program representation, when compiled and executed at runtime, no longer access the computed entity subsequent to the runtime access instructions. Delete instructions are generated and inserted into the program representation that compile to instructions to deallocate and delete the CE at the UTP at runtime (266). In some cases the compiler will recognize a first in a series of accesses within the program prior to the UTP. In this case, the first access causes the CE creation, and the subsequent accesses prior to the UTP do not. If it is unclear which access will be first in a set of access instructions, the compiler may add instructions for each access which check for existence of the CE and only create it when it is not already instantiated.

For MM3, when an access instruction is encountered for the CE (280), generate instructions to allocate and compute the CE coupled to the CE access at runtime (282). This is decoupled from IE instructions, like in MM2 260 and 262. However, instructions are inserted to check the existence of the CE first, and will allocate and compute the CE only for the first access. For subsequent accesses, the existence check will find the CE and therefore will not create one. Like MM1, if the CE exists, updates to the IE and CE are coupled. But, like MM2, if the CE does not exist, updates to the IE do not affect the CE. When an update instruction for the IE is encountered (284), then generate instructions to check CE exists, and, if so, recompute the computed entity coupled to the IE update (286). The generated instructions are inserted into the program representation such that instructions compiled from them are executed in a sequence subsequent to and coupled with instructions compiled from the IE update instruction at runtime. In this case, the generated instructions are coupled to the IE update. However, before CE creation (coupled to access), the generated instructions will simply check existence, fail to find it, and move on without CE update. Once CE exists, the updates themselves are coupled, like MM1. Similar to MM1, when a delete instruction for the IE is encountered (288), then generate instructions to delete the computed entity coupled to the IE delete (290). The generated instructions are inserted into the program representation such that instructions compiled from them are executed in a sequence subsequent to and coupled with instructions compiled from the IE delete instruction at runtime.

In an alternate embodiment, updates to IE and CE are decoupled. Instead, an update to the CE is coupled to an access of the CE. When the access occurs, the CE is validated to ensure it has a current value. If not, it is recomputed. Thus, the IE may be updated numerous times without any update of the CE. This approach may be employed in any of the three models. This approach is illustrated in the alternate flowchart 20 of FIG. 2D. The flowchart of FIG. 2D is the same for all steps related to creation and deletion within each of the three models. It is the update portions that are amended to illustrate the alternate embodiment. In each model the sensitivity to IE update is removed, and replaced with access sensitive instructions.

For MM1, when an access to the CE is encountered (254), generate instructions to validate the CE and conditionally recompute coupled to CE access (256). For MM2, the portion of the flowchart was already responsive to CE access. Here, instructions are generated to check the existence of the CE and allocate and compute it if not (270). Then instructions are generated to validate the existing CE and conditionally recompute the CE coupled to the CE access (272). MM3 already checked existence of the CE (282) responsive to an access instruction (280). Like MM2, instructions are generated to validate the existing CE and conditionally recompute the CE coupled to the CE access (292).

The three memory models introduced above are illustrated in FIG. 1A, one for each of the computed entities. Memory Model 1 (MM1) is selected for CE1 106. Memory Model 2 (MM2) is selected for CE2 107 Memory Model 3 (MM3) is selected for CE3 108. For each computed entity, first instructions are generated to allocate memory for the computed entity and are inserted into IR 140 in a manner according to the memory model selected for it such that the memory allocation is performed accordingly at runtime. The first instructions generated for the three example computed entities are Allocate CE1 151, Allocate CE2 153, and Allocate CE3 155. One possible aspect of a computed entity memory model is whether or not memory for the CE should be allocated when its IE memory is allocated. In this example, MM1 will so allocate, and MM2 and MM3 will not.

See FIG. 1B for illustration, which depicts IR 140 having been compiled into executable code 160 and loaded into a memory 150 for runtime execution. Runtime create instructions, Create D 161, are compiled from the create instructions of IR 140, Create D 142. Runtime first instructions for each computed entity, Allocate CE1 162, Allocate CE2 163, and Allocate CE3 167, are compiled from the respective first instructions of IR 140, Allocate CE1 151, Allocate CE2 153, and Allocate CE3 155. Responsive to selecting a first of the memory models, MM1 for CE1, first instructions, Allocate CE1 151, are inserted into IR 140 such that runtime first instructions 162 are executed in a sequence coupled with runtime create instructions 161 at runtime. Responsive to selecting a second of the memory models for each of CE 2 and CE 3, respectively, first instructions, Allocate CE2 153 and Allocate CE3 155, are inserted into IR 140 such that respective runtime first instructions 163 and 167 are executed in a sequence decoupled with runtime create instructions 161 at runtime. Thus, in FIG. 1A, Allocate CE1 151 is shown inserted into IR 140 coupled with Create D 142, while Allocate CE2 153 and Allocate CE3 155 are not. At runtime, when instructions Create D 161 are encountered, the DataType data object d 170 is instantiated in memory, along with independent entities ie1 171, ie2 172, and ie3 173. Notice that at time T0 there are no objects shown in memory 150, but at T1, data object d and its independent entities are instantiated. Following those instructions, the Allocate CE1 162 instructions are encountered, and thus computed entity ce1 174 is instantiated in memory as shown at time T1. The two sets of instructions are described as being coupled, as the runtime first instructions follow from the runtime create instructions, whether or not they are in direct sequence, and whether or not other instructions of various other types are carried out in between. The result is that the computed entity will be formed and available coupled with the formation and availability of the independent entity on which it depends. Note that at time T1, as the memory models MM2 and MM3 are defined to have computed entity memory allocation decoupled from the creation of the independent entity, ce2 and ce3 do not exist.

Another possible aspect of a memory model is whether memory allocation for a computed entity should be performed responsive to access of a computed entity. This is the case for example memory models 2 and 3. In FIG. 1B, runtime access instructions, Access CE2 164 and Access CE3 168, are compiled from access instructions of IR 140, Access CE2 143 and Access CE3 144, respectively. Responsive to selecting MM2 and MM3, respectively, first instructions Allocate CE2 153 and Allocate CE3 155 are inserted into IR 140 such that runtime instructions are executed in a sequence prior to and coupled with the runtime access instructions, 164 and 168, respectively, at runtime. Again, the instructions being coupled do not require any particular sequencing, direct or indirect, and allow for other instructions to be performed in between or simultaneously. FIG. 1B illustrates these resultant instantiations. Anticipating access to CE2, Allocate CE2 163 was compiled prior to and coupled with Access CE2 164 instructions, such that when Allocate CE2 163 instructions are encountered, computed entity ce2 175 is instantiated as depicted at time T2. Similarly, anticipating access to CE3, Allocate CE3 167 was compiled prior to and coupled with Access CE3 168 instructions, such that when Allocate CE3 167 instructions are encountered, computed entity ce3 176 is instantiated as depicted at time T4.

Other aspects of memory models include whether deallocation of memory for a computed entity, once such memory has been allocated, is coupled or decoupled to deallocation or deletion of an independent entity. Or, whether deallocation of memory for a computed entity is coupled to another event. In these examples, MM1 and MM3 will have deallocation of the memory for the computed entity coupled with the deletion of the independent entity. MM2 will have deallocation of the memory for the computed entity coupled with the end of a period of access of that computed entity.

In similar fashion to allocation, just described, second instructions to deallocate memory for a computed entity are generated. For CE1, CE2, and CE3, the second instructions are Deallocate CE1 152, Deallocate CE2 154, and Deallocate CE3 156, respectively. They will be inserted into IR 140 to accomplish the memory management aspects of each respective memory model at runtime.

Runtime delete instructions Delete D 169 are compiled from delete instructions of IR 140, Delete D 145. Runtime second instructions, Deallocate CE1 170, Deallocate CE2 166, and Deallocate CE3 171, are compiled from Deallocate CE1 152, Deallocate CE2 154, and Deallocate CE3 156, respectively. As shown in FIG. 1A, Deallocate CE1 152 and Deallocate CE3 156 are inserted in IR140 following Delete D 145, e.g. coupled to the delete of the independent entities on which CE1 and CE3 depend. At runtime, illustrated in FIG. 1B, the runtime second instructions for each of CE1 and CE3, 170 and 171, are executed in a sequence coupled with the runtime delete instructions 169, at runtime. The result is shown at T5, where data object d 170 including its independent entities ie1 171, ie2 172, and ie3 173 have been removed. Computed entities ce1 174 and ce3 176 have been deallocated as well.

For CE2, illustrating MM2, notice that in FIG. 1A the first and second instructions 153 and 154 for CE2 are surrounding the access instructions for that computed entity. As such, the CE will be allocated and computed, then accessed, then deallocated once access is finished. This process may be repeated any number of times. During compilation, a Usage Termination Point (UTP) is determined at which instructions compiled from the source code executed in a sequence subsequent to the runtime access instructions no longer access the computed entity for a period of time. This point is illustrated in FIG. 1B as UTP 165. Responsive to selecting memory model 2, the second instructions for CE2 (Deallocate CE2 154) are inserted into IR 140 such that the runtime second instructions are executed in a sequence subsequent to and coupled with a location associated with the usage termination point at runtime. Thus, Deallocate CE2 166 instructions are executed following UTP 165, and, as shown at time T3, ce2 175 is deallocated.

In summary, the allocation and deallocation pairs for each CE are inserted in the IR based on the memory model selected for each. In these examples, memory model 1 has the CE allocated and deallocated coupled with the creation and deletion of the independent entity on which it depends. In memory model 2, the allocation and deallocation of memory for CE2 is decoupled from both the creation and deletion of its independent entity. Instead, the allocation and deallocation are coupled with the access of CE2 and end of access (e.g. at the UTP) of CE2. Memory model 3 has allocation decoupled from creation of the independent entity and coupled with the access of CE3. Once allocated, its deallocation is not coupled with access, but with deletion of the independent entity.

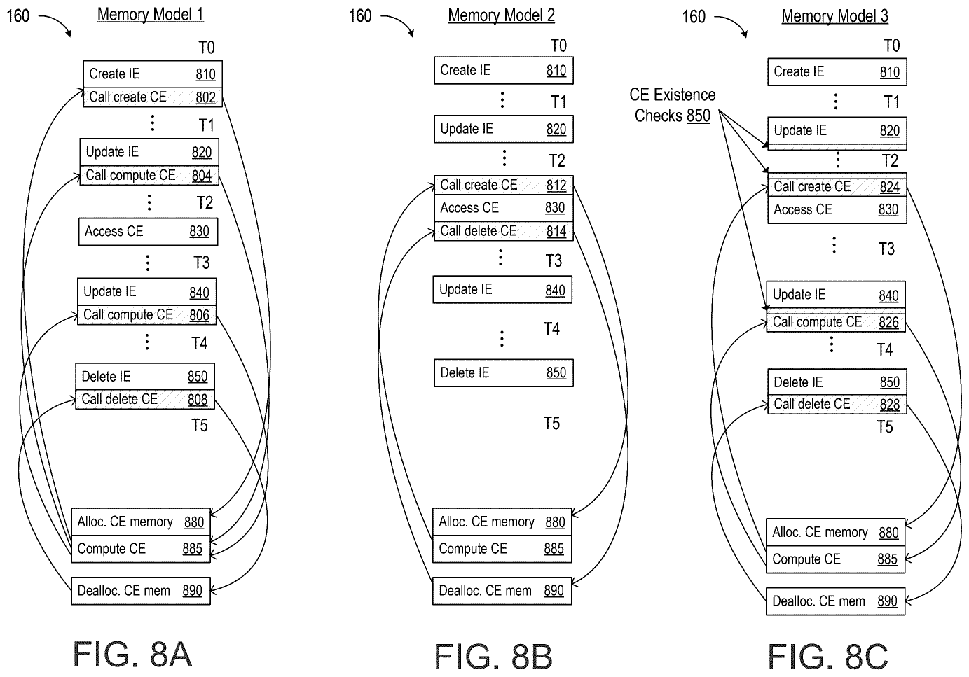

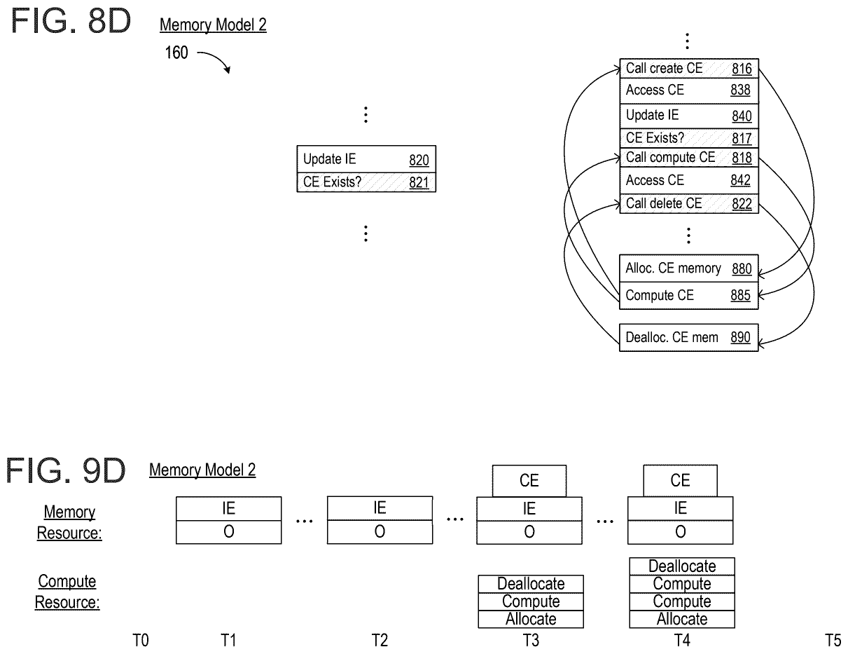

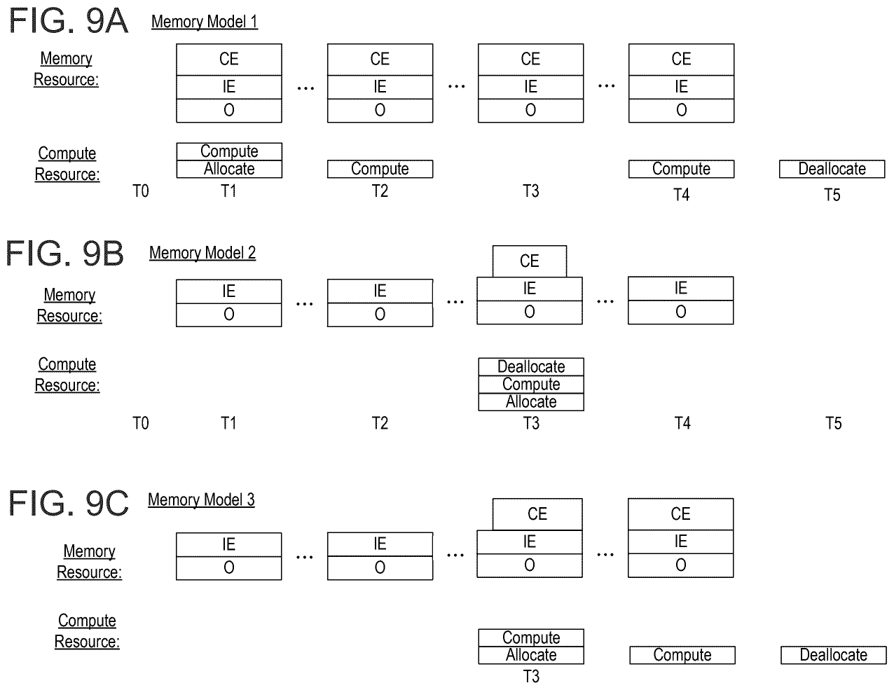

These memory models and various other memory model aspects are detailed further below. In addition, each memory model will have aspects defining relative computation of a computed entity in response to an update of the independent entity on which it depends. Update instructions may be generated from an update statement in source code 110, which compile to runtime update instructions. Third instructions to compute the computed entity are generated, which compile to runtime third instructions. The third instructions are inserted into IR 140 such that the runtime third instructions are executed in a sequence coupled with the runtime update instructions at runtime. Alternatively, fourth instructions are generated to determine whether the computed entity exists in memory at runtime and to call the runtime third instructions responsive to the computed entity existing at runtime. The fourth instructions compile to runtime fourth instructions. The fourth instructions are inserted into IR 140 such that the runtime fourth instructions are executed in a sequence coupled with the runtime update instructions at runtime. These and other examples are illustrated below with respect to FIGS. 8A-8D and 9A-D.

FIGS. 1A and 1B illustrated LLMM 120 generating memory allocation and deallocation instructions and inserting those instructions in an intermediate representation, which is one embodiment. The compiler may operate in general on any program representation, processing and analyzing the program representation, and inserting instructions into the same or a different representation of the program. Example program representations include source code in a high-level programming language, an intermediate representation in general, an IR such as an Abstract Syntax Tree (AST), LLVM, machine code, and others.

FIG. 1C illustrates alternate embodiments of generating LLMM code for computed entity memory management in computational device 100. As in FIG. 1A, compiler 130 comprising LLMM module 120 scans source code 110 for computed entities and determines which memory model to assign to each of them. In these embodiments, the instructions to allocate memory for, compute, and deallocate memory for computed entities are generated in the form of event handlers and calls to those event handlers. Placing the calls to the event handlers in the code at differing locations determined in accordance with the different selected memory causes the appropriate memory management for the selected memory model to be executed at runtime. A first embodiment is shown identified by solid lines, where LLMM 120 emits computed entity event handlers into IR 140. The calls to those event handlers are also generated and attached to IR 140, in accordance with the selected memory model for each computed entity. IR 140 may be further processed as necessary, and ultimately processed by code generation unit to provide executable code 160. Note that code generation may be carried out in multiple phases. For example, a low-level language such as c/llvm may be an intermediate target of code generation 185. An intermediate level compilation can be further processed into executable code for one or more target processors and/or architectures.

It is typical in a compiler for an Abstract Syntax Tree (AST) 180 to be generated from source code 180 and used for analysis and other compiling functions. In one embodiment, event handlers are emitted in AST format for each computed entity and stitched to AST 180. AST 180 may be converted into another form of Intermediate Representation (IR) 140. Note that AST 180 is itself a form of IR, and IR 140 is not required to be a different format. A variety of additional compilation processes may be carried out on IR 140, until it is ready for code generation. Instructions to call event handlers for each computed entity are then attached to IR 140 before code generation module 185 generates executable code 160. The locations of those calls will vary in accordance with the memory model selected. The emission of event handlers and attachment of calls to them are illustrated by dashed lines in FIG. 1C.

Yet another embodiment is illustrated by the dotted lines in FIG. 1C. Here, the event handlers and calls can be generated in the source code language used in source code 110 and inserted into source code 110. The updated source code can then be compiled in ordinary fashion, and the memory management for each memory model will be implemented automatically. Note also that the phase of code analysis need not match the phase of generated code insertion. E.g., analysis may be performed on AST 180, or source code 110 directly, or any other phase of IR 140. Any number of other embodiments may be deployed where LLMM instructions are generated in any compiler phase or code format. The description herein for compiler 130 support of LLMM is provided illustratively. It will be appreciated that it may be implemented in alternate ways over any of various phases and passes of compilation, using the principles described herein.

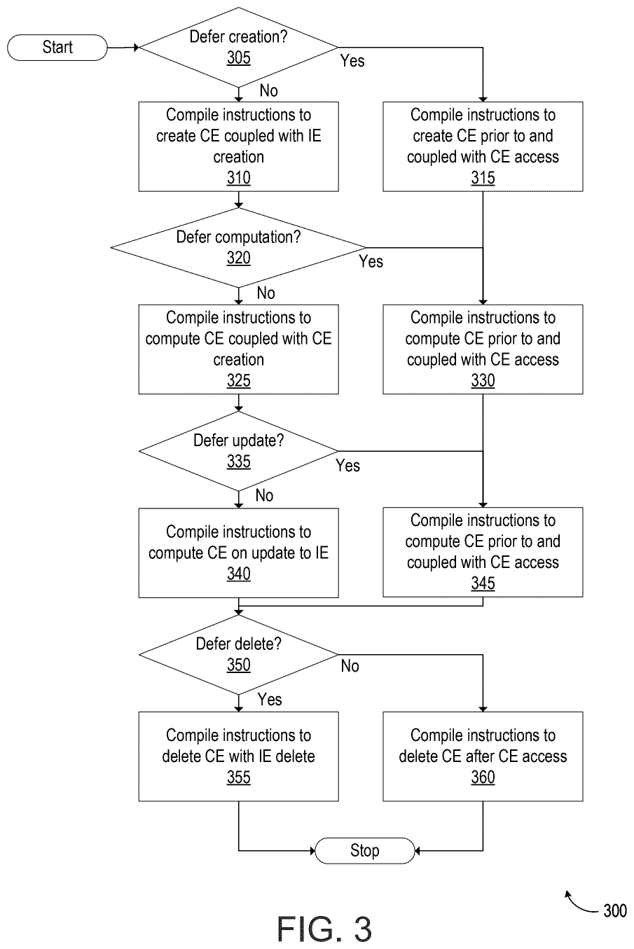

FIG. 3 is a flowchart 300 illustrating example factors that can be used in memory model selection by LLMM 120. Memory usage of and computational cost of a computed entity may influence which factors are used in selecting or creating a memory model. If it is desirable to defer creation of a computed entity (305) then compile instructions to create that computed entity coupled to when the computed entity is accessed (315). If deferring creation is not desirable, then compile instructions to create that computed entity coupled to when the independent entity on which it depends is created. One advantage of deferring creation of the computed entity is that its required memory can be used for other purposes until it needs to be accessed. One advantage for not deferring is that the response time to retrieve the computed entity will be faster when its memory is already allocated. In this regard, it may be desirable not to defer computation of the CE (320), such that it not only has memory allocated, but is computed and available for access rapidly. In this case, compile instructions to compute the CE coupled with CE creation (325), i.e. memory allocation. However, if computation deferral is desired (320), or when creation of the CE is deferred (315), then instructions are compiled to compute the CE prior to and coupled with CE access (330). One scenario in which deferring computation of a CE may be when the memory cost for the CE is low, and the computational resource required for allocation is low, but the requirement for access of the CE may be contingent or unlikely, or the CE is likely to be updated prior to access. A compiler may analyze usage of the CE throughout the source code to determine how and when to vary the memory model selection for a CE.

In either case, a memory model can also be selected to defer an update of a CE (335) or not. If deferral is desired then compile instructions to compute the CE prior to and coupled with CE access (345). Otherwise compile instructions to compute the CE coupled with an update to the independent entity on which the CE depends. In both of these instances, a decision to defer deletion or not (350) can be included in a memory model. Here, a CE can be deleted (or have memory deallocated) following and coupled to a CE access, and instructions so compiled (360). This is done when it is desirable for memory to be freed for other use in between accesses of a CE. Or instructions can be compiled to delete or deallocate memory for the CE coupled with instructions to delete or deallocate the IE on which it depends (355). In this case the CE and its memory persists along with the IE. Then the process stops. Any number of memory models can be devised for use in a compiler in response to computational and memory cost for a CE and the context in which it and its IE are used in the source code. The steps in FIG. 3 are illustrative only. Alternate embodiments may include additional memory model options, or fewer. For example, consider a model where computation of a CE is never deferred from its creation. In this case, decision block 320 can be ignored, and steps 310 and 325 will always be performed when creation (305) is not deferred, and steps 315 and 330 are always performed when creation is deferred.

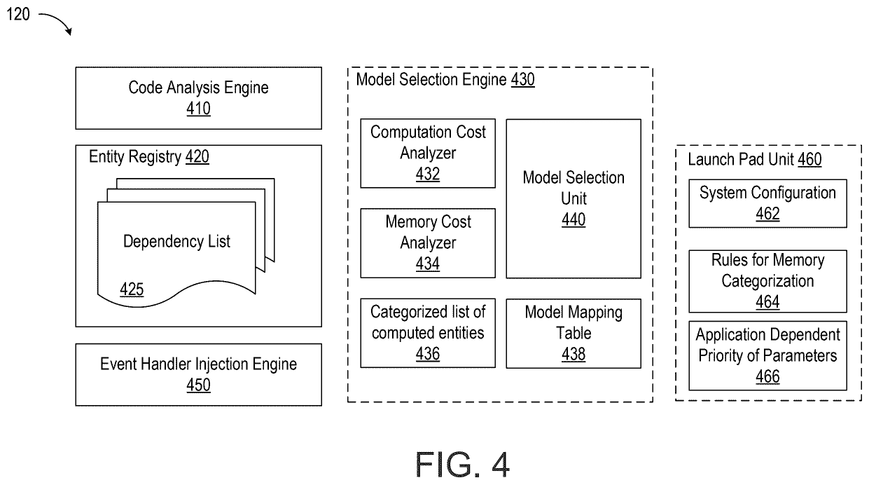

FIG. 4 illustrates an example architecture of a Low-Level Memory Management (LLMM) module 120. It comprises Code Analysis Engine 410, Entity Registry 420, Model Selection Engine 430, Event Handler Injection Engine 450, and Launch Pad Unit 460.

The Code Analysis Engine 410 scans the source code and captures all the computed entities, the independent entities, and the dependencies between the independent and computed entities and loads them into the Dependency List 425 in the Entity Registry 420. It also captures events like create, update, and delete of independent entities, invocation of computed entities, identifying the independent entities on which the computed entities depend, and determines the usage termination point of the computed entities. A categorized list of computed entities 436 comprising this relevant information is delivered to the Model Selection Engine 430.

The Launch Pad unit 460 is used to supply the Memory Selection Engine (430) with information and settings to facilitate the selection of the appropriate memory model for each computed entity. They can be configured by a user or a system administrator and may be set by or shared with other users in a distributed IDE, e.g. for collaborating on a project.

System Configuration 462 comprises system configuration information for the target system or systems for which the application, e.g. executable code 160, is being compiled. The Rules for Memory Categorization 464 are a set of rules framed by a system administrator, for example, based on the system configuration and nature of the application to categorize a range of memory costs for use in memory model selection. In this example, low, moderate, and high memory costs are defined. Application Dependent Priority of Parameters 466 provides preferences appropriate to the application being designed, such as defining whether the application is time constrained or memory constrained, which can be used in memory model selection.

The Model Selection Engine 430 selects the memory model for each of the computed entities in the source code. The components involved in this decision-making are the Computation Cost Analyzer 432, the Memory Cost Analyzer 434, the categorized list of computed entities 436, the Model Mapping Table 438, and the Model Selection Unit 440.

Computation Cost Analyzer 432 is responsible for assessing the computational cost of every computed entity. In this embodiment, every computed entity is categorized as having low, moderate, or high computational cost based on the computation operation, or the complexity of queries involved in calculating the computed entity. This information is stored in the categorized list of computed entities 436.

Memory Cost Analyzer 434 is responsible for assessing the memory cost involved for every computed entity by considering the system configuration 462, Rules for Memory Categorization 464 from the Launch Pad Unit 460, and the data size (known at compile time or hinted in the source code) of and on which the computed entity operates. This information is included in the categorized list of computed entities 436.

The categorized list of computed entities 436 includes all computed entities, their associated computation cost and memory cost, along with the number of occurrences of these entities, their frequency of usage throughout the source code, and the scope of each access or access to occurrences of the computed entities.

The Model Selection Unit 440 fetches details of each computed entity from the categorized list of computed entities 436 and maps it to the appropriate pattern in the sample Model Mapping Table 438 to find the memory model allocated to this entity. The chosen model is stored in the categorized list 436 corresponding to each computed entity.

Table 1 illustrates an example Model Mapping Table 438. If the combination of costs of a computed entity falls within the first seven patterns, the corresponding memory model is selected. For patterns 1 and 2, model 1 is selected. For pattern 3, model 2 is selected. For patterns 4 through 7, model 3 is selected. If pattern 8 or 9 is encountered, the Model Selection Unit 440 fetches the Application Dependent Priority of Parameters 466 from the Launch Pad Unit 460. If the application is primarily concerned about the computational cost, model 3 is chosen. If memory is the primary concern, model 2 is allocated.

TABLE 1
Sample Model Mapping Table

| Pattern No. | Computation Cost | Memory Cost | Memory Model |
|---|---|---|---|
| 1 | Low | Low | Model 1 |
| 2 | Moderate | Low | Model 1 |
| 3 | Low | High | Model 2 |
| 4 | Moderate | High | Model 3 |
| 5 | High | Low | Model 3 |
| 6 | High | Moderate | Model 3 |
| 7 | High | High | Model 3 |
| 8 | Low | Moderate | Model 2 or 3 |
| 9 | Moderate | Moderate | based on app. |
| | | | Priority of |
| | | | Parameters |

In the foregoing example, memory models are precomputed and stored, with additional computation by Model Selection Unit 440 as required, such that, in this example, the model choices for patterns 8 and 9 are entered based on the application settings. In an alternate embodiment, rather than accessing precomputed and stored memory models, the model selection is computed on demand, using any variety of functions and formulas required to implement a desired set of memory models.

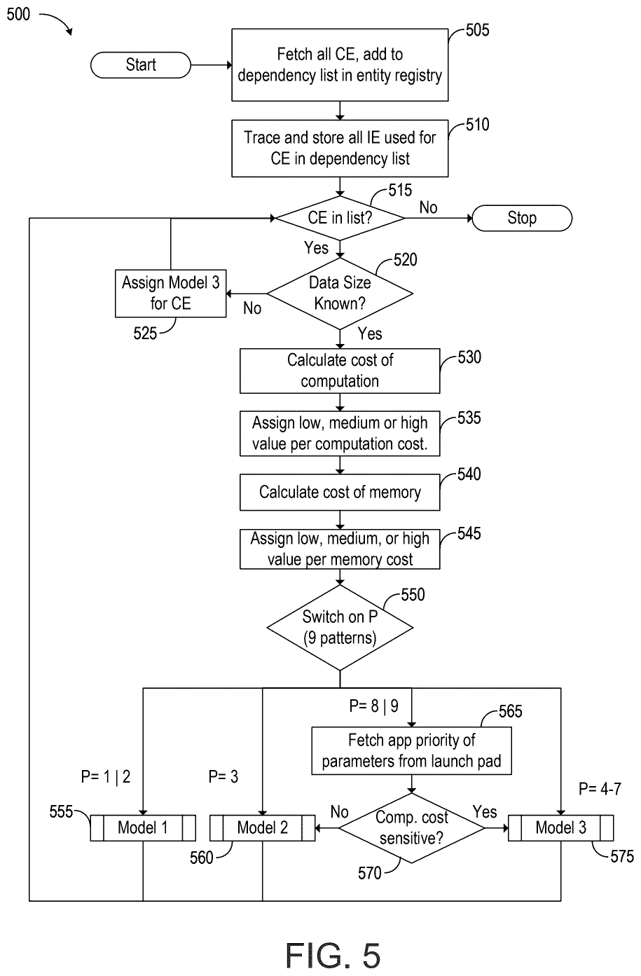

FIG. 5 is a flowchart 500 illustrating computing and selecting memory models for computed entities. It serves as one example of step 210 introduced above with respect to FIG. 2. As described above, all the computed entities are fetched (505) from source code 110 and added to a dependency list 425 in an entity registry 420. For each computed entity in the dependency list, trace and store all the independent entities required to generate the computed entity (510). Loop through each computed entity in the list (515). If a computed entity is found, check if the data size is known (520) at compile time or a hint of the data size is given in the source code. Sometimes the data size will be known, or an estimate can be made by the compiler. In this embodiment, if no memory size data is available, and there is no reasonable estimate to determine otherwise, model 3 is selected for the CE, and the process returns to find the next CE in the list, if any (515). Other embodiments may make other assumptions in the absence of data.

If the data size required to compute and store the CE is known or estimable, calculate the cost of computation (530). Assign a low, medium, or high value (535) according to the rules for memory categorization 464. Determine the actual or hinted data size (540). In many instances the data size will be defined a priori. In other instances, the specific data size may not be known with precision, but an evaluation of relative size is possible. For example, a computed entity may be generated from a population having a minimum size. An illustration detailed further below computes salaries for a subset of employees of a large organization, the subset having a minimum size. A low, medium, or high value is assigned (545) to the computed entity, using the known size, or the potential size expected with a certain probability.

Then the model for the computed entity is assigned based on a switch (550) on the 9 patterns formed by the possible combinations of computational complexity and memory requirement. This example uses the patterns shown in Table 1. When the pattern is 1 or 2, model 1 is assigned (555). When the pattern is 3, model 2 is assigned (560). Model 3 is assigned for patterns 4, 5, 6, and 7 (575). For patterns 8 and 9, additional steps are introduced. Fetch (565) the application priority parameters 466 from launch pad 460, to determine the sensitivity for the particular application being developed. If computational cost is the primary sensitivity (570), assign model 3 (575). Otherwise, assign model 2 (560). Then the process loops back to 515 to process the next CE, until the list is exhausted, and the process terminates.

Returning to FIG. 4, the Event Handler Injection Engine 450 analyzes the user code and generates instructions for each computed entity. In this embodiment, the CE instructions (215) comprise the relevant event handlers based on the memory model assigned for the computed entity, as well as the calls to those event handlers (220). The event handlers and their calls are injected into the user code. In various embodiments, the code may be introduced in one or more differing stages of compilation. The resultant compiled code will yield comparable expected performance results at runtime, but the compilation process itself may differ in performance depending on the embodiment. For example, in one embodiment, the handlers and calls can be generated as strings and inserted into the source code itself. In another embodiment, the handlers and calls can be generated in an intermediate representation format, such as AST nodes, and included in the AST for further compiling in the semantic analysis phase. In another embodiment, tree nodes equivalent to the event handlers are stitched to the root of the AST generated for the user code in the semantic analysis phase, and appropriate calls to these event handlers are introduced to the IR for inclusion in the final executable code during the code generation phase.

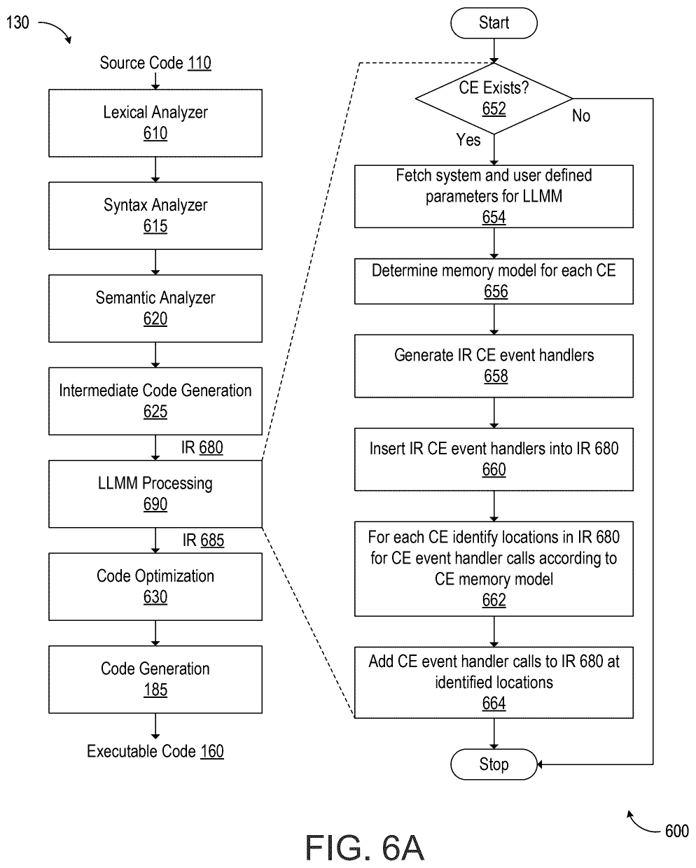

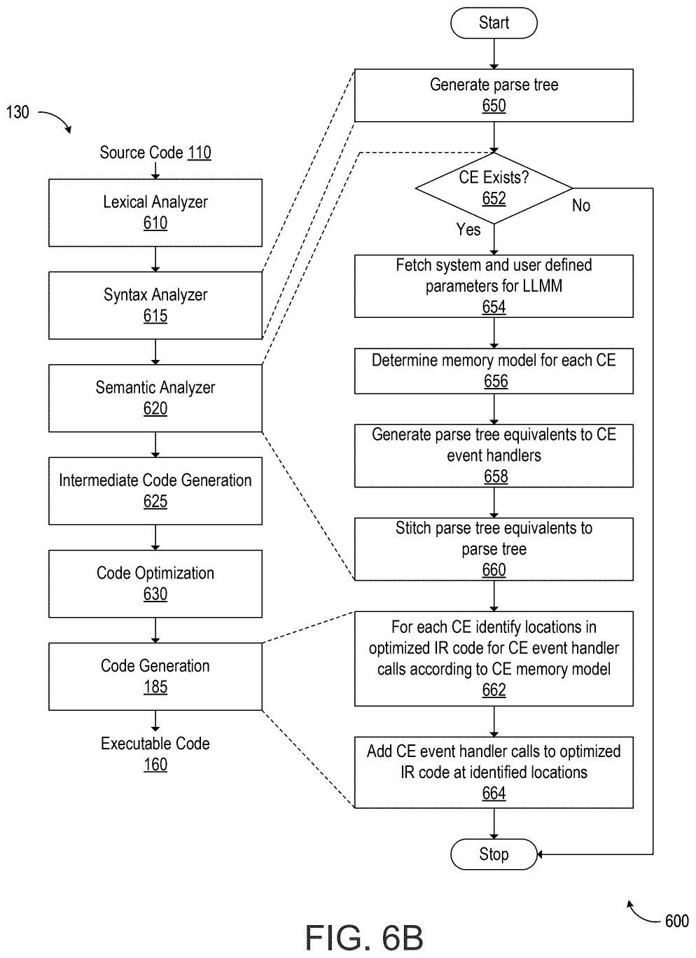

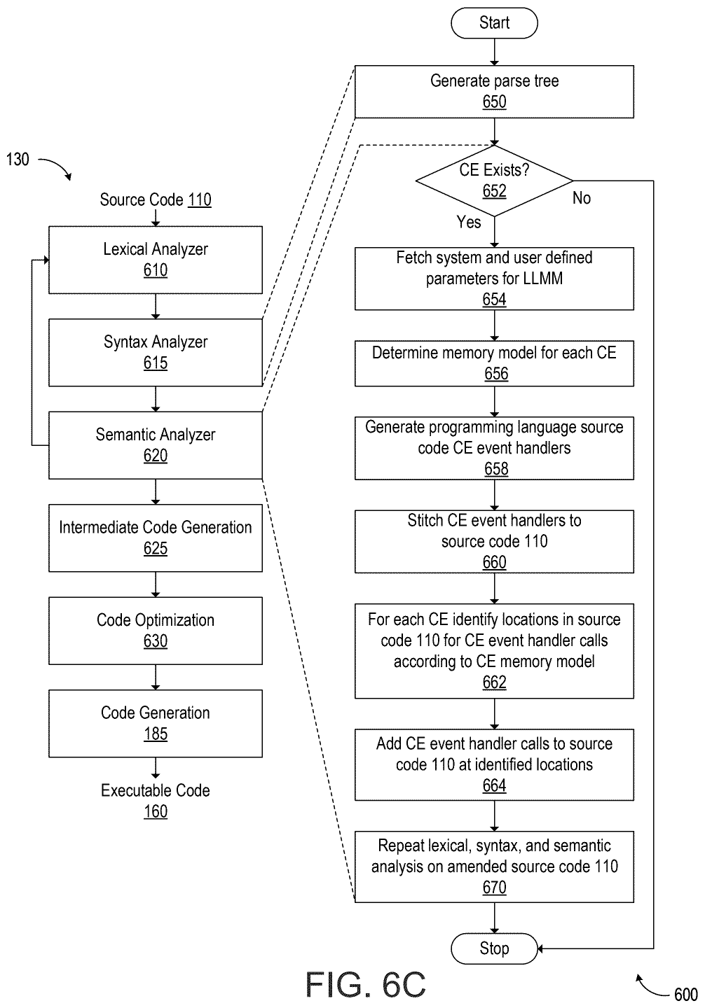

FIG. 6A is an example compiler 130 with a flowchart 600 illustrating LLMM processing on an intermediate representation. Lexical analyzer 610 performs lexical analysis, also known as scanning, where source code is 110 is converted into a sequence of lexical units or tokens. Tokens are the smallest meaningful units of a programming language, such as keywords, identifiers, operators, and literals.

Syntax analyzer 615 performs syntax analysis, also known as parsing, where the compiler checks whether the sequence of tokens generated by the lexical analyzer 610 conforms to the rules defined by the programming language's grammar. This analysis typically involves constructing a parse tree or syntax tree (e.g. an AST) that represents the hierarchical structure of the source code.

Semantic analyzer 620 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. It also performs various optimizations and transformations based on the semantic properties of the code.

Intermediate code generation module 625 generates an intermediate representation (IR) 680 of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. IR 680 may be any of a variety of forms, including but not necessarily an AST.

In this embodiment, LLMM processing module 690 operates on IR 680 to produce IR 685, using a process illustrated as flowchart 600 for optimization of memory management for computed entities. IR 680 is evaluated to locate any computed entities (652). If none are found flowchart 600 terminates. To process memory management for located computed entities, fetch system and user-defined parameters for low-level memory management, as detailed above (654). Determine a memory model for each computed entity (656), e.g. using the method illustrated in FIG. 5. Computed entity event handlers are generated (658) in accordance with the selected memory model. The event handlers for each computed entity are inserted into IR 680 (660). For each CE, responsive to its assigned memory model, locations are identified (662) within the IR code 680 to place event handlers for that CE. Calls to the appropriate event handlers are inserted into the IR 680 at the identified locations (664). Flowchart 600 then terminates, and any further compiling continues.

Code optimization module 630 is where the intermediate representation, IR 685 in this example, is improved to enhance its efficiency in terms of execution time, memory usage, or other performance metrics. During code optimization, the compiler applies various techniques and transformations to the intermediate code to eliminate redundant operations, minimize resource usage, and improve the overall quality of the generated code. Optimization techniques may include constant folding, dead code elimination, loop optimization, and many others. The primary goal of code optimization is to produce optimized code that executes more efficiently on the target platform, resulting in improved performance and reduced resource consumption. Other embodiments may employ different or additional compiler phases processing the IR for other purposes.

Code generation module 185 is where the optimized intermediate representation of the source code is translated into executable machine code specific to the target platform. During code generation, the compiler maps the instructions and constructs of the intermediate code to the corresponding machine instructions of and taking advantage of the specific features and optimizations offered by the target architecture. This involves generating assembly code or machine code that directly controls the behavior of the target hardware. Note that code generation may be carried out in multiple phases. For example, a low-level language such as c/llvm may be an intermediate target of code generation 185. An intermediate level compilation can be further processed into executable code for one or more target processors and/or architectures.

FIG. 6B is an example compiler 130 with flowchart 600 modified to illustrate LLMM stitching parse tree equivalent event handlers to an AST during semantic analysis and adding calls during code generation. In this embodiment, flowchart 600 begins during the syntax analysis phase in which the parse tree is generated (650). Other embodiments may employ different or additional compiler phases processing an AST or parse tree for other purposes. Here, semantic analysis includes optimization of memory management for computed entities. The parse tree is evaluated to locate any computed entities (652). If none are found then routine compilation continues, but flowchart 600 terminates. To process memory management for located computed entities, fetch system and user-defined parameters for low-level memory management, as detailed above (654). Determine a memory model for each computed entity (656), e.g. using the method illustrated in FIG. 5. Parse tree equivalents for computed entity event handlers are generated (658). The event handlers for each computed entity, in parse tree format, are then stitched to the root node of the generated parse tree (660).

Additional analysis during the semantic analysis phase may provide information for use in determining or implementing a memory model. For example, when implementing memory model 2, a Usage Termination Point (UTP) for a CE identifies the point at which a CE which has been accessed, perhaps multiple times, is no longer in use (at least for a certain time period). This allows the LLMM to be able to select when to delete the created CE operating using memory model 2. Note that a model 2 CE will also be deleted upon deletion of the independent entity, if the CE is existing at the time (e.g., the program execution is within the UTP).

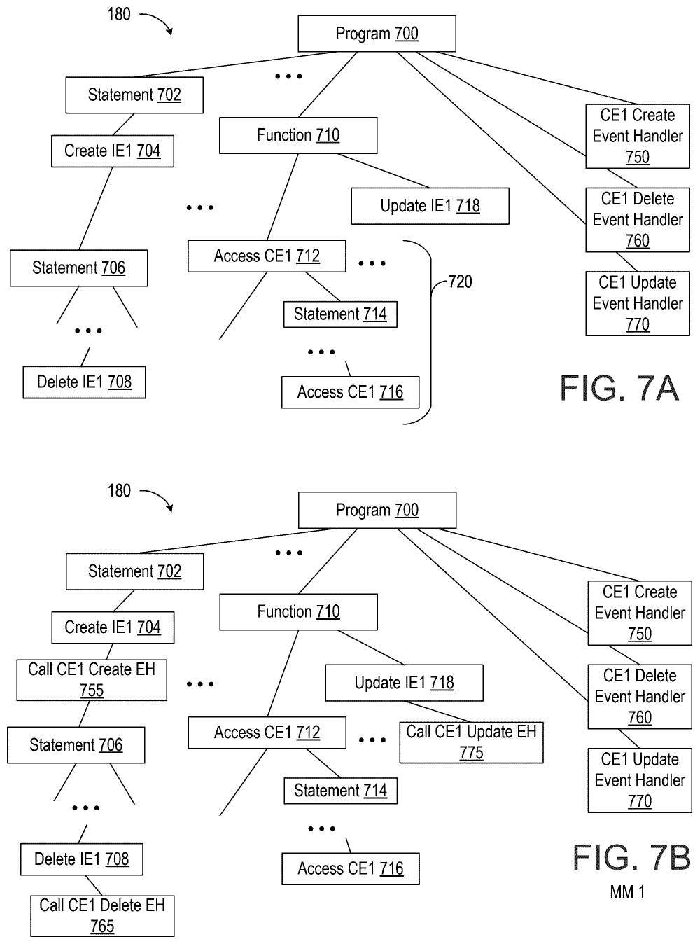

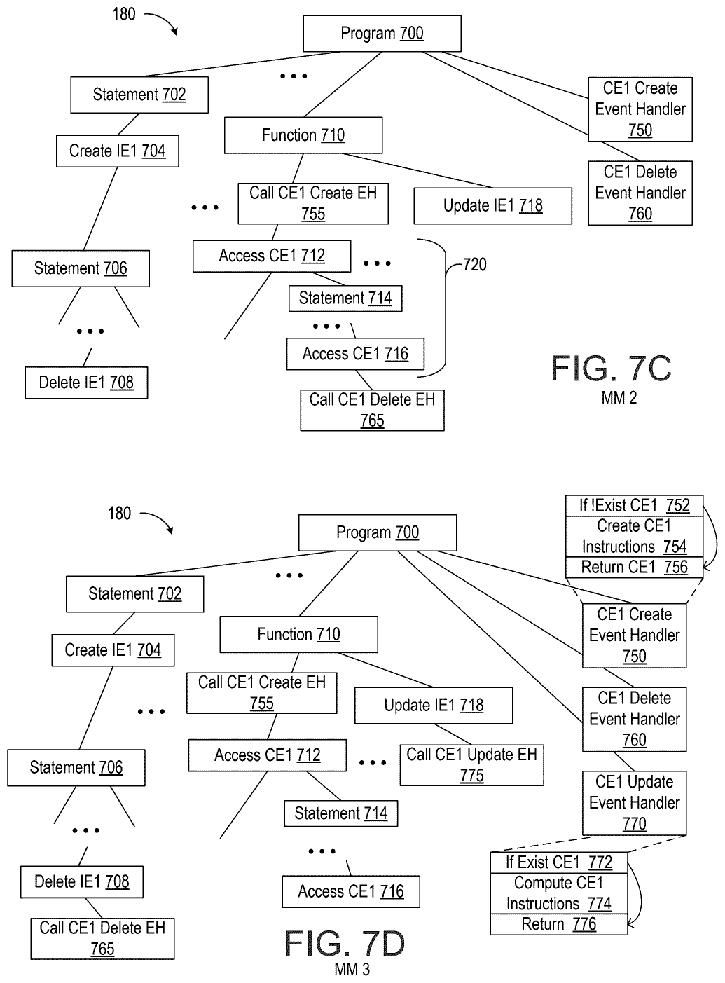

FIG. 7A is a graphical representation of a sample abstract syntax or parse tree 180. It is not intended to represent a complete parse tree, but rather fragments of pseudocode branches and statements are shown for illustration of the process of flowchart 600. The root node, program 700, has a variety of branches represented by statement 702 and function 710, as well as any number of additional branches in between them. A create statement 704 calls for create instructions for the creation of an independent entity, IE1. Statement 704 is followed by additional statements such as statement 706. Function 710 is followed by statement 712, which calls for an access to computed entity CE1, which is dependent on IE1. Additional statements, including statement 714, follow access CE statement 712 before an additional access to CE1 is found in access CE statement 716. A bracket 720 illustrates an example UTP relative to access 712 of CE1. An update to IE1 is called for by Update CE1 statement 718. At some point subsequent to statement 706, a delete statement 708 for IE1 is encountered. The pieces described thus far form a representation of the generated parse tree (650) prior to the stitching step (660).

To continue the illustration of modified flowchart 600 of FIG. 6B, parse tree 180 is scanned for any computed entities (652). Semantic analyzer 620 will have located CE1 (and any others not shown) and determined a memory model for it (656) based on parameters (654), and parse tree equivalents to CE event handlers for the computed entity (customized as necessary for the memory model selected) are generated (658). In the example embodiment, the event handlers are emitted in Abstract Syntax Tree (AST) format, equivalent to what would otherwise be compiled from source code of those event handlers. Three event handlers, one to create CE1 750, one to delete CE1 760, and one to update CE1 770 are illustrated in FIG. 7A, and they are stitched (660) to the root of parse tree 180 (at program 700).

During the code generation phase, flowchart 600 continues. For each CE, responsive to its assigned memory model, locations are identified (662) within the optimized IR code to place event handlers for that CE. Calls to the appropriate event handlers are inserted into the optimized code at the identified locations (664). Flowchart 600 then terminates, and code generation (and any further compiling) continues until executable code 160 is produced.

To illustrate locating and inserting calls, the parse trees of FIG. 7B-D are modifications of FIG. 7A, including inserting a call 755 to CE1 create event handler 750, a call 765 to CE1 delete event handler 760, and, where necessary, a call 775 to CE1 update event handler 770. The parse tree representation is for illustrative purposes only. As detailed above, prior to code generation, the compilation process in the example embodiment will have produced an IR as well as one or more optimized IRs, and code generation will be operating on that form of code.

FIG. 7B illustrates inserted calls when memory model 1 is assigned to CE1. The parse tree of FIG. 7B is identical that of FIG. 7A, except for the call insertions appropriate for memory model 1. Recall that, in this model, creation, updating, and deletion of the computed entity are coupled with those respective functions applied to the independent entity. Thus, the 755 call to create CE1 occurs linked to or coupled with the creation of its independent entity 704. CE1 will already be created and available during any of the accesses 712 or 714. If an update to IE1 occurs, such as Update IE1 718, call 775 to the CE1 update event handler is called. CE1 remains until a call 765 to delete CE1 760, which is inserted coupled with the delete 708 of its independent entity.

FIG. 7C illustrates inserted calls when memory model 2 has been assigned to CE1. With this model, the creation of CE1 occurs linked to and coupled with its access, not with the creation of its independent entity. Access 712 starts the period where CE1 is on demand, so the LLMM 120 knows to inject the 755 call to create CE1 750 prior to access 712. As introduced in FIG. 7A, note that bracket 720 identifies a portion of code during which CE1 should be available. This is an example of semantic analysis finding the UTP for CE1, which is found to be after access 716, letting the LLMM 120 know to inject the call 765 to delete CE1 760 subsequent to the UTP. In this example, a design choice has been made that prevents instructions with updates to IE1 while processing within the scope of the access and its UTP. Therefore, there is no need for updating CE1, and so CE1 Update event handler 770 has not been stitched to AST 180, and naturally no calls to that event handler are required. As described previously, the access, 712 in this example, causes memory to be allocated for the computed entity, and causes the computed entity to be computed, which will be dependent on the independent entity as modified by any updates that have occurred prior. Once the access period is over, as delineated by the UTP, the computed entity is deleted and associated memory deallocated, so future updates to the independent entity will not have an effect on the CE, except and unless a new access to the CE is encountered. This design choice is not a requirement, and an alternate is discussed further below.

FIG. 7D illustrates inserted calls when memory model 3 has been assigned to CE1. Like with memory model 2, the creation of CE1 occurs linked to and coupled with its access, not with the creation of its independent entity. Access 712 starts the period where CE1 is on demand, so the LLMM 120 knows to inject the 755 call to create CE1 750 prior to access 712. In contrast to memory model 2, and similar to memory model 1, with memory model 3, CE1 persists, once created, until IE1 is deleted. Therefore, a call 765 to the Delete CE1 event handler 760 is inserted subsequent to and coupled with delete IE1 708.

In addition to location of calls, an event handler may vary based on the selected memory model. For example, CE1 Create event handler 750 for memory models 1 and 2, as detailed with respect to FIGS. 7B and 7C, includes instructions to create the computed entity, coupled to IE creation or CE access, respectively. However, as just described for memory model 3, CE1 is created upon first access, and remains in memory until IE1 is deleted. If there are multiple access statements including CE1, it may not be known which, if any, access statement will be the first to access CE1. And it would be redundant and wasteful to recreate CE1 for subsequent accesses. To facilitate these constraints, CE1 Create event handler 750 for memory model 3 is modified to include a check 752 for CEL existence. If it does not exist, then the handler executes Create CE1 instructions 754 to allocate memory for and compute CE1. If CE1 exists (752) then the create instructions 754 are skipped. In either case CE1, already existed or newly created, is returned (756).

A modification for CE1 Update event handler 770 is also included for memory model 3. Detailed above, in memory model 1, an update to IE1 is coupled with a call to event handler 770 and CE1 is updated without condition. And in the version of memory model 2 detailed in FIG. 7C, there is no need to update CE1, as it is created, computed, and deleted all during a period where IE1 is not updated. But for memory model 3, an update to IE1 is ignored when CE1 has not yet been accessed, and hence not yet created. Once created, however, an update to IE1 is coupled with an update to CE1. To facilitate this, an update to IE1, such as Update IE1 718, has a call 775 to the CE1 Update event handler 770. Event handler 770 includes CE1 existence check 772. If CE1 exists, then instructions to compute CE1 774 are executed, and the process then returns 776. If CE1 does not exist (772) then no computation is performed, and the process returns (776).

This same modification to CE1 Update event handler 770 can be incorporated into an alternate embodiment of memory model 2 (details not shown). As introduced above, it is not mandatory to prevent updates to an independent entity during a scope of accessing a dependent computed entity. In that case, it may not be known whether an update to IE1 is occurring while CE1 exists. So, modifying the AST of FIG. 7C, the update event handler 770 of FIG. 7D can be stitched to AST 180. A call 775 to that event handler 770 can be inserted following update CE1 718, similar to FIG. 7D. In this case, only when CE1 is created and within the scope of an access and UTP will an update to IE1 cause a recompute of CE1. In all other instances, the computation of CE1 is avoided with the minor computational overhead of an existence check.

FIG. 6C is an example compiler 130 with flowchart 600 modified to illustrate stitching source code event handlers and associated calls to source code 110 during semantic analysis. Here the flowchart 600 is identical to that detailed with respect to FIG. 6A, except that event handlers are generated in source code format rather than IR format (658), and handlers and calls are inserted into source code 110 rather than IR 680 (660, 662, and 664). Furthermore, once the pass of semantic analysis in which the LLMM processing occurs is finished, the process loops back to repeat lexical, syntax, and semantic analysis on the amended source code 110 (670).

In the example embodiment of FIG. 6B, stitching AST event handler code during the semantic analysis phase and inserting calls to those handlers during the code generation phase realizes the benefit of low-level memory management with possibly reduced compiling computation requirements. In an alternate embodiment, described earlier, the calls could be introduced into the AST in the semantic analysis phase along with the event handlers. Since an AST is a form of intermediate representation, this is a subtype of the embodiment detailed in FIG. 6A, although rather than occurring in a separate LLMM processing phase 690, the AST is updated during semantic analysis 620. In contrast to the embodiment of FIG. 6B, this would lead to those calls being processed during the intermediate code generation and code optimization phases. In the embodiment described in FIG. 6C, the event handlers and calls to those handlers could be generated and introduced at the source code level. This would also require processing during the intermediate code generation and code optimization phases and would require an additional pass through the lexical analyzer 610, syntax analyzer 615, and semantic analyzer 620. Nonetheless, any of these embodiments, and any other that allows the compiler to assign memory models to computed entities as described may be deployed. Again, any number of other embodiments may be deployed where LLMM instructions are generated in any compiler phase or code format. The description relating to FIGS. 6A-6C for compiler 130 support of LLMM is provided illustratively. It will be appreciated that it may be implemented in alternate ways over any of various phases and passes of compilation, using the principles described herein.

FIGS. 8A-C show example executable code 160 for each of the three memory models, using the following code snippet for illustration. FIGS. 9A-C show graphical representations of memory usage and computational resource used for comparing aspects of each model.

| 1 | // Pseudocode for illustrating various memory models at runtime | |
|---|---|---|
| 2 | | |
| 3 | Object:= Type | |
| 4 | IE:= ... | //some type of independent entity |
| 5 | CE: function(object.ie)... | //computed entity a function |
| | | of the IE |

...

| | | |
|---|---|---|
| 10 | O <- create (object(...)...) | //create object O |

...

| | | |
|---|---|---|
| 20 | <- o.ie.update(...) | //update independent entity |

...

| | | |
|---|---|---|
| 30 | C = function(o.ce) ... | //access computed entity |

...

| | | |
|---|---|---|
| 40 | <- o.ie.update(...) | //update independent entity |

...

| | | |
|---|---|---|
| 50 | <- delete(o) | //object O deleted |

### Example 1. Pseudocode Used in Illustrating Various Memory Models at Runtime

In the Example 1 pseudocode, Object is defined as a Type (line 3). An Object has an independent entity labeled IE, which can be any element or group of elements (line 4). The Object also has a computed entity, CE, which is a function of the independent entity, as illustrated by the example function (object.ie) (line5). In the source code, “:=” denotes a type or element declaration and “:” denotes element or object usage. The use of pascal case (PascalCase) for object and element identifiers indicates a declaration and the use of snake case (snake_case) represents object and element usage. The delimiter “//” identifies comments. The ellipses are used to indicate that some number of statements may occur between the illustrative statements.

Line 10 creates an Object labeled “O”. Some number of instructions later, in line 20, the independent entity IE of object O is updated. Some number of instructions later, in line 30, the computed entity CE of object O is accessed. The independent entity IE is updated again sometime later at line 40. Eventually the object O is deleted in line 50.

FIGS. 8A-C illustrate the operation of executable code 160 compiled from source code and having LLMM 120 select memory model 1, 2, or 3, respectively, for computed entity CE. The layout of executable code 160 and how it is loaded into memory at runtime is illustrative only. Executable code can be loaded in any portion of memory, contiguously or otherwise, in similar order to the stored executable, or rearranged, or in any other configuration. The same is true for objects and other runtime data. It is common practice for instructions to be stored in a stack, and object data to be stored in a heap, but any memory management technique may be employed. FIGS. 9A-C illustrate the comparative memory resource for the object O, IE and CE, and compute resource for CE, at times T0-T5 for the respective memory models.

For each model, lines 10, 20, 30, 40 and 50 have been compiled into create IE instructions 810, update IE instructions 820, access CE instructions 830, update IE instructions 840, and delete IE instructions 850, respectively. Appropriate AST event handlers were generated and stitched during semantic analysis. Those handlers were compiled into instructions comprising instructions 880 to allocate memory for CE, instructions 885 to compute CE, and instructions 890 to deallocate memory for CE. Calls to the respective event handlers were injected during code generation, at different locations based on selected memory model, which after compilation result in the calls to the allocation, computation, and deallocation instructions. Various other instructions may have also been generated from the event handlers during compilation, not shown. The sets of calls and instructions shown serve to illustrate the three models at runtime.

FIG. 8A illustrates memory model 1. In this model the creation of a computed entity is coupled to the creation of the independent entity, the computed entity is updated following and linked to an update of the independent entity, and the computed entity persists until the independent entity is deleted. The instructions do not need to be exactly in sequence, but the effect will be such that CE exists while IE exists and updates to IE link to updates to CE so that CE can be accessed without computational delay caused by creating or computing it. As such, a call to create CE 802 is linked to the create IE 810 instructions. The calls to compute (or update) CE 804 and 806 are coupled to update IE 820 and 840 instructions. The call to delete CE 808 is coupled to delete IE 850 instructions.

At runtime, when create IE instructions 810 are encountered and executed, a call to create CE 802 is next, which, in addition to other possible event handler instructions (not shown), calls and executes instructions 880 to allocate memory for CE. In this embodiment, instructions to compute CE 885 follow automatically after memory allocation (other memory models can de-link computation and creation, as illustrated in FIG. 3). After the CE memory allocation and computation, the process returns to continue execution. Turning to FIG. 9A, at time T0, the object O has not been created, and neither has IE. After the call to create CE 802 is completed, at T1, the memory resource used is that of the object O, IE, and CE. The compute resource included memory allocation and CE computation.

When update IE instructions 820 are encountered and executed, a call to compute CE 804 is next, which, in addition to other possible event handler instructions (not shown), calls and executes instructions 885 to update CE in response to the update of IE. After the CE update, the process returns to continue execution. At T2, the memory resource remains the same, and the compute resource includes CE computation.

When access CE instructions 830 are encountered, CE is already updated and available. No event handler calls are required in this memory model. As such, the memory resource remains unchanged at T2, and no compute resource to manage CE is required.

When the second update IE instructions 840 are encountered and executed, a call to compute CE 806 is next, which calls and executes instructions 885 to update CE once more in response to the update of IE. After the CE update, the process returns to continue execution. At T4, like at T2, the memory resource remains the same, and the compute resource includes CE computation.

The independent entity IE is deleted along with object O, as encountered in instructions 850, which prompts a call to delete CE 808, which in addition to other possible event handler instructions (not shown), calls and executes instructions 890 to deallocate CE memory in response to the deletion of IE. After the CE memory deallocation, the process returns to continue execution. At T5, the memory resource has the object O, IE and CE removed, and the compute resource includes CE memory deallocation.

FIG. 8B illustrates memory model 2. In this model the creation of a computed entity is linked to the access of the computed entity, and the computed entity is deleted once the UTP is reached. The creation and deletion of CE is disconnected from dependence on creation and deletion of the IE. Thus, as the CE is created and deleted at the beginning and end of this scope, there is no need for an update handler or instructions for the CE. The instructions do not need to be exactly in sequence, but the effect will be such that the CE exists while it is on demand for computation. As such, instructions 810 and 850 serve to create and delete, respectively, object O and IE in exactly the same fashion as detailed above for memory model 1. This is seen in memory resource T1-T4, with no memory resource in T0 or T5. In contrast, at T1 and T2, when create IE instructions 810 are encountered, no memory allocation for CE or computation is expended. Update IE instructions 820 have no effect, as CE is not existent.

In this example, similar to that illustrated in FIG. 7C, updates to an IE do not result in an update to a dependent CE, as updates are prevented by design, while the CE is in the scope of an access. In alternate embodiments this design limitation is not imposed. An update to the IE results in an update to the CE if the IE update occurs while the CE is existent in memory. This alternate is described with respect to FIGS. 8D and 9D, below.

Prior to encountering CE access instructions 830, a call to create CE 812 is executed, which, in addition to other possible event handler instructions (not shown), calls and executes instructions 880 to allocate memory for CE. Instructions to compute CE 885 follow automatically after memory allocation. After the CE memory allocation and computation, the process returns to continue execution, where access CE instructions 830 may be executed. When the UTP for CE has been reached, then call to delete CE instructions 814 will call CE memory deallocation instructions 890. FIG. 9B illustrates the resource usage. IE and object memory remain throughout T1-T4, but CE memory is only allocated during a portion of time T3 prior to CE access and after UTP. The compute resource is an allocate, compute, and deallocate of the CE.

After deallocation, the process returns to continue execution. When the second update IE instructions 840 are encountered and executed, there is no effect as the CE is not existent. When the independent entity IE is deleted along with object O, as encountered in instructions 850, there is no effect on the CE, as it is already deleted. The deletion and deallocation of object O and IE is as described above with respect to memory model 1. There is no additional CE memory or compute resource expended.

Memory model 3, illustrated in FIG. 8C, operates identically to memory model 2 in FIG. 8B until after CE access instructions 830 are executed, except for the minor computational overhead of checking CE existence 850, as detailed above with respect to FIG. 7D. Following Update IE 820, a check for CE is false (850), so no CE computation follows. There is no significant memory or compute resource expended for CE in periods T0-T2 (see FIG. 9C). A call 824 to execute instructions 880 to allocate memory for CE and instructions to compute CE 885 follows automatically, as before. Here, the CE check 850 is still false, so the CE creation instructions 880 and 885 are executed. Thereafter, the rest of the process mirrors that of memory model 1, as shown in FIG. 8A. After access of the CE, there is no delete and deallocation. The CE memory resource persists through T4, and there is no deallocate compute resource expended in T3.

In contrast to memory model 2, and similar to memory model 1, when the second update IE instructions 840 are encountered and executed, a CE existence check returns true, so a call to compute CE 826 is next, which calls and executes instructions 885 to update CE in response to the update of IE. After the CE update, the process returns to continue execution. At T4, like at T2, the memory resource is the same as in FIG. 9A, and the compute resource includes CE computation (existence check computation is considered negligible in this example).

The independent entity IE is deleted along with object O, as encountered in instructions 850, which prompts a call to delete CE 828, which calls and executes instructions 890 to deallocate CE memory in response to the deletion of IE. After the CE memory deallocation, the process returns to continue execution. At T5, the memory resource has the object O, IE and CE removed, and the compute resource includes CE memory deallocation.

These three illustrations highlight some of the differences between the models and can assist developers evaluating tradeoffs in tuning the LLMM to provide the results desired. MM1 uses the maximum amount of memory and can in some cases have an increased computational load if updates to IE result in CE computations that aren't accessed. However, CE is always available without a delay when needed. This specific example highlights the best-case scenario for MM2. It uses the least amount of memory allocation for CE, while also requiring the minimum amount of compute resource. It will be apparent that in scenarios with multiple accesses, the computational requirements will scale accordingly. MM3 takes advantage of the benefits of MM2 until CE is created, and then it behaves more like MM1, providing a blend between the two.

To gain a more balanced perspective, consider the scenario illustrated in FIG. 8D. A modification to executable 160, in which everything is identical to the previous illustration except that an access to the CE (838) occurs prior to and an access to the CE (842) occurs subsequent to the second update to IE 840. Furthermore, the design constraint of this embodiment of memory model 2 allows for updates to IE while CE exists, resulting in the potential for a recompute requirement for CE (described above following the discussion of FIG. 7D). First, note that in contrast to the embodiment of MM2 shown in FIG. 8B, update IE 820 could possibly result in an update to CE, so existence check 821 instructions are introduced following. In this example, CE does not exist, so no recompute is carried out. Again, the existence check is considered relatively computationally negligible, as shown at T2 in FIG. 9D.

Additional changes are illustrated at T4 in FIG. 8D. A call to create CE 816 is inserted prior to access CE 838. The UTP is calculated to be after CE access 842, so a call to delete CE 822 is inserted there. A CE existence check 817 and a call to compute CE 818 is inserted after the IE update 840 since the updated CE will be required for access 842. In this example, CE exists so the call to compute CE 818 will cause compute CE instructions 885 to be carried out. The resultant resources used are shown in FIG. 9D. The resources are identical to FIG. 9B for T0 through T3. In T4, additional memory is allocated, as the CE is created once more by the call to allocate CE memory 880 from create CE instructions 816. CE is subsequently computed 885. When the compute CE call 818 is encountered, compute CE 885 instructions are executed once more. CE is deallocated once more following the call to delete CE 822. T5 is the same as T5 in FIG. 9B.

In this illustration, the memory requirements are essentially the same between MM2 and MM3, but now MM2 has more compute resources required. These simplified examples illustrate the types of tradeoffs to be made. This is why computations of memory requirements and complexity of the actual compute functions are used in selecting memory models. For a low memory CE, the benefits of MM2 or MM3 may be negligible compared to MM1. For a highly intensive computation, with many “unused” updates triggered by updates to IE, then even with repeated allocation/deallocation overhead MM2 may significantly outperform the other models. Naturally, the sensitivity of the target environment to memory or compute resources will also be a factor. Those of skill in the art will readily deploy these principles in optimizing the parameters to define memory models and analyze code to determine how and when to apply each to a particular set of computed entities.

Note that the previous examples have assumed that a CE, when existing, will be recomputed directly upon an update to an IE on which it depends, a so-called eager strategy. Alternate strategies may be substituted. For example, a computed entity existing in memory may be updated only when there is an access to the computed entity, not immediately after the update of the independent entity. To ensure correctness of the computed entity, times are maintained for the computation of the CE and the creation or update of the IE. Upon access to the computed entity, the CE time is verified with the IE time. If the computed entity has been computed before the update of the independent entity, then the computed entity is recomputed. Otherwise, the computed entity is up to date and its value can be used. This same time stamp verification technique can be employed in memory models 1 and 3 as well, to decouple CE recompute from IE update. Instead, CE recompute is coupled with CE access and performed as necessary based on the time stamp verification.

Following are 3 sets of examples, each set used to illustrate one of the three memory models. Each set contains user developed code, represented with numerical line numbers, incorporating an independent entity and a computed entity. Each set also contains compiler generated code, e.g. by LLMM 120, represented with alphabetic line numbers. The compiler generated code is shown as source code for illustrative purposes. As detailed above, LLMM generated source code can be attached to user code and compiled in one embodiment, compiled into an AST format and stitched to the root of the AST, or generated and inserted in any IR format. Calls to the LLMM code will be inserted as detailed above, in a manner responsive to the memory model selected for a given computed entity. Various embodiments are envisioned, including inserting calls as source code, calls in AST format inserted during semantic analysis, within any type of IR during an LLMM processing phase, or in any of a number of formats prior to or during code generation.

Example 2 represents the developer code to illustrate Memory Model 1.

| 1 | // Model 1: Calculating age of a Person | |
|---|---|---|
| 2 | // Model 1: Low memory and Low computation | |
| 3 | Person:= Type | |
| 4 | Dob:= Date | // independent entity |
| 5 | Age: @now − person.dob | // Computed entity dependent on |
| | | // IE within same type |

| | |
|---|---|
| 6 | |
| 7 | @ready(console) //main |
| 8 | P <- create(person(dob: 1990-10-02)) |
| 9 | |
| 10 | after(p) //person creation is successful |
| 11 | U <- update(p.dob): 1996-09-12 |
| 12 | |
| 13 | after(u) |
| 14 | <- delete(p) |

### Example 2. Pseudocode to Illustrate Memory Model 1

A type identifier “Type” defines data type Person (line 3) as user defined. A set of related statements (lines 4-5) define elements of Person: Dob (line 4) and Age (line 5) representing the date of birth and age of the Person. Dob is datatype Date and is an independent entity. In this example it is a user-creatable entity which is given by the user directly or through a URL. The computed entity Age is identified with the operator “:” assigning it to be computed as @now-person.Dob which is the difference between the current date and the person's date of birth.

The trigger @ready (line 7) is a construct that invokes an operation on reception of a request from the console. It contains the block of statements in lines 8-14. It invokes the create statement for the Person object (P) (line 8). The “<-” operator is used to submit a create, update, delete or append operation to the compiler. The create statement includes the Person and its property Dob. Here, p indicates the person object.

The “after” in after (p) statement (line 10) is a synchronization construct that ensures that after the successful creation of a Person object, the subsequent instructions are executed. The update statement (line 11) is invoked for the Person object's Dob. Here, u indicates the updated field for the person object. The after (u) statement (line 13) ensures that person object is updated successfully, and the subsequent sections are executed. The deletion of the Person object (line 14) is invoked through the delete statement on successful updating to u.

For the user code given in Example 2, the LLMM 120 in concert with semantic analyzer 620 of compiler 130 generates a parse tree equivalent to the following code shown in Example 3 in response to the code in Example 2 and stitches it to the original parse tree created from the user code.

Example 3 shows the compiler-generated instructions for Memory Model 1 in response to the user code in Example 2.

| | |
|---|---|
| A | //compiler generated code for Model 1 |
| B | @create(person.dob) |
| C | <- create(person.age(@now − person.dob)) |
| D | |
| E | @update(person.dob) |
| F | <- update(person.age, person.age(@now − person.dob))) |
| G | |
| H | @delete(person.dob) |
| I | <- delete(person.age) |

### Example 3. Illustrative Compiler-Generated Pseudocode for Memory Model 1

The computed entity Age is created when the independent entity Dob on which it depends is created in response to the create statement (line 8) for the independent entity Dob, the compiler generates a response LLMM code as shown in lines B & C. Memory is allocated to the computed entity Age and its value is computed directly. This @create event handler is an example of a CE1 Create event handler 750, detailed above with respect to FIG. 7B.

The computed entity Age is updated when the independent entity Dob on which it depends is updated in response to the update statement (line 11) for the user creatable entity Dob. The compiler generates a response LLMM code as shown in lines E & F. The value of the computed entity Age is recomputed. Here, no memory allocation or deallocation happens. This @update event handler is an example of a CE1 Update event handler 770, detailed above with respect to FIG. 7B.

The computed entity Age is deleted when the independent entity Dob on which it depends is deleted in response to the delete statement (line 14) for the user creatable entity Dob. Dob is an element of the person object and hence the deletion of the person object deletes the Dob. The compiler, aware of the dependency of Age on Dob, responsive to the Dob deletion generates LLMM code as shown in lines H & I. The computed entity Age is deleted, and the memory allocated to it is also deallocated. This @delete event handler is an example of a CE1 Delete event handler 760, detailed above with respect to FIG. 7B.

In this example, a parse tree equivalent to the above generated code is stitched to the original parse tree generated by the compiler for the user code. The code generation phase adds calls to these events at appropriate locations of the final executable code generated by the compiler. In memory model 1, the calls are placed linked to the creation, updating, and deletion of the IE, as detailed above in FIG. 8A. In this simplified example used for illustration of compiler-generated code, there are no significant instructions in between the create, update, and delete, and so the differences at runtime between memory model 1 and memory model 2 are not highlighted here. Those differences are understood readily from the discussion above contrasting FIGS. 8A and 9A with FIGS. 8B, 8D, 9B, and 9D.

Memory Model 2 for a computed entity is based on the principle that when a computed entity's object is on demand, it is created by allocating memory. When the computed entity's usage is over, then its object is deleted by deallocating memory. Example 4 represents user code to illustrate Memory Model 2.

| 1 | // Model 2: High memory \| moderate computation | |
|---|---|---|
| 2 | | |
| 3 | Organization:= Type//container type for Team type | |
| 4 | Team[ ] | //ordered list, containment of Organization type |
| 5 | | |
| 6 | Organization/Team:= Type | |
| 7 | Employee[ ] | //containment of the container Team |

| | | | |
|---|---|---|---|
| 8 | AllEmpSalary[ ]: team.employee[ ].salary[ ] | //CE of a type | (Team)dependent on an IE of a different type |

| | (Employee) | | |
|---|---|---|---|
| 9 | !InvalidCount: error(team.employee[ ].count < 500000) | | |
| 10 | | | |
| 11 | Team/Employee:= Type | | |
| 12 | Salary:= Number // Independent entity | | |
| 13 | Designation:= String | | |
| 14 | | | |
| 15 | TeamCost:= Expression | | |
| 16 | parameter | | |
| 17 | T: team //formal argument | | |
| 18 | return | | |
| 19 | print | | |
| 20 | t.all_emp_salary[ ].sum | //invokes creation of | |
| | | CE all_emp_salary[ ] | |
| 21 | t.all_emp_salary[ ].min | | |
| 22 | t.all_emp_salary[ ].max | | |
| 23 | t.all_emp_salary[ ].sum | | |
| 24 | | | |
| 25 | @create(http.request(url: “create_org”)) | | |
| 26 | O <- create | | |
| 27 | organization | | |
| 28 | team[ ]: [ ] | | |
| 29 | for_each(T, in: request.team_info[ ]) | | |
| 30 | | team | |
| 31 | | employee[ ]: [ ] | |
| 32 | | for_each(Emp, in: t.emp_info[ ]) | |
| 33 | | employee(salary:emp.salary, | designation: emp.designation) |

| | |
|---|---|
| 34 | after(o) |
| 35 | <- console.log[ ].append(team_cost(t: o.team[1])) |
| 36 | // o.team[1] is selected as an example arg for team_cost |

### Example 4. Pseudocode to Illustrate Memory Model 2

In Example 4, a type identifier Type defines data type Organization (line 3) as user-defined. Organization has an element Team declared as a sequence (line 4). A sequence is denoted as “[ ]” and it represents a list of items. So, an organization with 3 teams will have a Team sequence comprising the list of teams, including team [1], team [2], and team [3]. A sequence can also be a type. The organization type in line 3 is a container for the team type in line 4. Here, sequence Team is declared as a type (line 6), having three elements (lines 7-9): sequence Employee (line 7), AllEmpSalary as a computed entity (line 8), and InvalidCount as a constraint (line 9). The Employee sequence is also declared as a type (line 11) with two elements: Salary, a number (line 12), and Designation, a string (line 13). Employee type in line 7 is a containment within the container type Team in line 6. Computed entity in line 8, within the container Team, is computed from the independent entity Salary in the containment Employee.

Computed entity AllEmpSalary is a list comprising a salary for each employee in the sequence Employee, formed using the expression team.employee [ ].salary [ ]. Team, Employee and Salary are independent entities on which computed entity AllEmpSalary depends. The InvalidCount constraint (line 9) states that the team instance's employee count must never fall below 500000. The constraint is validated during the creation of a team instance or during an update on the team instance's employee [ ].

In an alternate embodiment, the size constraint can be given directly given in source code by the user as illustrated in the alternative code block below:

| | |
|---|---|
| 6 | Organization/Team:= Type |
| 7 | Employee[ ](min_size : 500000) //Employee[ ] is assigned a minimum size of 500,000 |
| 8 | AllEmpSalary[ ]: team.employee[ ].salary[ ] |

Line 7 indicates that the minimum size of Employee [ ] is 500000. This is fetched by the compiler during compilation as the data size.

TeamCost is an expression declared in line 15. TeamCost takes team (T) as a parameter using the keyword parameter (line 17). It is followed by a return statement (line 18). The return statement returns the sum of salaries of all employees (line 23) belonging to a team. Line 19 is a print statement that prints the sum, max and min of AllEmpSalary.

When an http request comes from the user (line 25) to create an organization type, it invokes the create statement (lines 26-27) to create an organization object denoted O. An organization has a set of teams (line 28). Each team has its own set of employees (lines 30-31). Each employee of every team has information regarding designation and salary. First, the employee sequence is constructed using the designation and salary details (lines 31-33), followed by constructing the team sequence (lines 29-30) and, finally, constructing the organization (lines 26-30). After successfully creating an organization (line 34), the team_cost is printed as output in line 35.

In this example, during compilation, memory model 2 is selected for the AllEmpSalary computed entity. Compiler generated code responsive to that selection is shown in Example 5.

| | |
|---|---|
| A | @call(team.all_emp_salary[ ]) |
| B | for_each(I, in: team.employee[ ]) |
| C | append(team.all_emp_salary[ ], i.salary) |
| D | |
| E | after(@usage(team.all_emp_salary[ ])) |
| F | delete(team.all_emp_salary[ ]) |

### Example 5. Illustrative Compiler-Generated Pseudocode for Memory Model 2

On encountering a call to the computed entity in line 20, the compiler generates the code instructions in lines A-C. When there is a demand for the computed entity all_emp_salary [ ] based on an access from user code, then the @call event handler is executed, and creation of the computed entity occurs as shown in lines B-C. In this case, for each employee in a team, the employee's salary is fetched and appended to the team's all_emp_salary [ ] sequence. This @call event handler is an example of a CE1 Create event handler 750 described above with respect to FIG. 7C.

The compiler generates code for deletion and deallocation of memory occupied by the computed entity all_emp_salary [ ] as shown in lines E-F. This event handler is executed using the after keyword which is triggered when @usage of all_emp_salary [ ] is completed. The compiler determines the location in code (whether IR in general, AST, or source code) as the UTP determined by the after (@usage statement in line E. In this example, the computed entity is accessed starting at line 20 and ending at line 23, so the UTP will be located after line 23. This after@usage event handler is an example of a CE1 Delete event handler 760 described above with respect to FIG. 7C. This process of creation & computation of computed entity and the deallocation at the Usage Termination Point is carried out for all instances of access to the computed entity in the user code (other accesses not shown).

In this example, a parse tree equivalent to the above generated code is stitched to the original parse tree generated by the compiler for the user code. The code generation phase adds a call to these events at appropriate locations based on the selected memory model. Here the compiler generates a call for deletion of the computed entity after its usage is over, after the execution of line 19 in Example 4.

Example 6 represents the developer code to illustrate Memory Model 3. When the computed entity's object is first on demand, then memory is allocated for it, and it is computed. When the user independent entity is updated, then, if the computed entity exists, the dependent computed entity is also recomputed. If the computed entity has not yet been created (e.g. it has not yet been accessed), then an update to the independent entity does not result in updating the computed entity. The computed entity, once created, persists while independent entities on which it depends exist. When the object that holds the independent entity is deleted, the computed entity is also deleted, and its memory is deallocated.

| 1 | // -------------------------------------------- | |
|---|---|---|
| 2 | // Model 3: Computation: High, Memory: Moderate | |
| 3 | Organization:= Type | |
| 4 | Team[ ] | |
| 5 | | |
| 6 | Organization/Team:= Type | |
| 7 | Employee[ ] | |
| 8 | ExpMlsSalary[ ]: team.employee[ ](employee.designation == “MLS” and? employee.experience > 10 | |
| | and? employee.salary > 150000).salary[ ] | //CE of a type(Team)dependent on an IE of a different type |
| | (Employee) | |
| 9 | ExpMtsSalary[ ]: team.employee[ ](employee.designation == “MTS” and? employee.experience > 10 | |
| | and? employee.salary > 50000).salary[ ] | //CE of a type(Team)dependent on an IE of a different type |
| | (Employee) | |
| 10 | !InvalidCount: error(team.employee[ ](employee.designation == “MLS” and? employee.experience > | |
| | 10 and? employee.salary > 150000).count < 70000) | |
| 11 | !InvalidMtsCount: error(team.employee[ ](employee.designation == “MTS” and? | |
| | employee.experience > 10 and? employee.salary > 50000).count < 70000) | |
| 12 | | |
| 13 | Team/Employee:= Type | |
| 14 | Salary:= Number | //Independent entity |
| 15 | Designation:= String//Independent entity | |
| 16 | Experience:= Number | //Independent entity |
| 17 | | |
| 18 | TeamMlsCost:= Expression | |
| 19 | parameter | |
| 20 | T: team | |
| 21 | return | |
| 22 | print | |
| 23 | t.exp_mls_salary[ ].sum | //invokes creation of exp_mls_salary[ ] |
| 24 | t.exp_mls_salary[ ].min | |
| 25 | t.exp_mls_salary[ ].max | |
| 26 | t.exp_mls_salary[ ].sum | |
| 27 | | |
| 28 | // ------------------------------------ | |
| 29 | | |
| 30 | @create(http.request(url: “create_org”)) | |
| 31 | O <- create | |
| 32 | organization | |
| 33 | team[ ]: [ ] | |
| 34 | for_each(T, in: request.team_info[ ]) | |
| 35 | team | |
| 36 | employee[ ]: [ ] | |
| 37 | for_each(Emp, in: t.emp_info[ ]) | |
| 38 | employee(salary: emp.salary, designation: emp.designation, experience: emp.exp) | |
| 39 | after(o) | |
| 40 | <- console.log[ ].append(team_mls_cost(t: o.team[1])) | |
| 41 | | |
| 42 | @create(http.request(url: “add_employee”)) | |
| 43 | <- append | |
| 44 | organization.team[1](team.id == request.team_id).employee[ ] | |
| 45 | employee | |
| 46 | salary: request.emp_info.salary | |
| 47 | designation: request.emp_info.designation | |
| 448 | experience: request.emp_info.exp | |
| 49 | | |
| 50 | @create(http.request(url: “update_employee_salary”)) | |
| 51 | <- update | |
| 52 | organization.team[1](team.id == | request.team_id).employee[1](id == |

| | |
|---|---|
| | request.emp_id)).salary |
| 53 | request.salary |
| 54 | |
| 55 | @create(http.request(url: “delete_employee”)) |
| 56 | <- remove |
| 57 | organization.team[ ](team.id == request.team_id).employee[ ] |
| 58 | element: organization.team[ ](team.id == request.team_id).employee[1](id == request.emp_id) |

### Example 6. Pseudocode to Illustrate Memory Model 3

Organization (line 3) is a user-defined type and denotes a user-creatable entity. Organization has element Team declared as a sequence (line 4) and a type (line 6). Team has five elements (lines 7-11): sequence Employee (line 7), computed entity ExpMlsSalary (line 8), computed entity ExpMtsSalary (line 9), constraint InvalidCount (line 10), and constraint InvalidMtsCount (line 11). Sequence Employee is a type (line 13) with three elements: number Salary (line 14), string Designation (line 15) and number Experience (line 16).

The computed entity ExpMlsSalary (Experienced Member of Leadership Staff) is defined (line 8) as a sequence comprising a salary for each employee in the sequence Employee meeting the criteria defined using the expression requiring a designation of MLS, experience greater than 10, and salary greater than 150,000.

The computed entity ExpMtsSalary (Experienced Member of Technical Staff Salary) is defined (line 9) as a sequence comprising a salary for each employee in the sequence Employee meeting the criteria defined using the expression requiring a designation of MTS, experience greater than 10, and salary greater than 150,000.

The InvalidCount is a constraint (line 10) that checks the following condition: if the count of all such experienced employees (designation is MLS, with experience more than 10 years and salary greater than Rs 150,000) in a team is less than 70,000, then an error is generated at runtime. The error indicates that if the employee count is not greater than 70,000, then Team cannot be created. The Team and Employee are also user creatable entities for the computed entity. Here, the value 70,000 acts as a hint to the compiler stating that the size of a single team cannot be less than this number. This hint is used in estimating the cost of memory involved in the computed entity as shown in flowchart 500 of FIG. 5. In similar fashion, InvalidMtsCount is a constraint (line 11) that checks that the count of experienced technical employees remains at or above 70,000, or an error will be generated at runtime.

TeamMlsCost is a Type expression declared in line 18. Here, the parameter T (line 20) denotes the expression belongs to the type Team. It is followed by a return statement (line 21). The return statement returns the sum of salaries of all experienced employees (line 26) belonging to the team T. Line 22 is a print statement that prints the sum, max and min of the ExpMtsSalary.

When an http request comes from the user (line 30) to create an object of type organization, it invokes the create statement (lines 31-32) to create an organization object called O. Lines (30-38) are similar to the lines 25-33 detailed in Example 4, with the addition of the element experience for an employee. An organization has a set of teams with employees and each employee's details like salary, designation, and experience are maintained. First, the employee sequence is constructed using those details (lines 36-38), followed by constructing the team sequence (lines 34-35), and, finally, constructing the organization (lines 31-33). After the creation of organization is successful (line 39), the team_mls_cost is printed as output in line 40.

In a similar manner, if there is an http request from the user for any updating to the organization object, for example, to add a new employee (lines 42-48), update the fields of an employee (lines 50-53), or delete an employee from the organization (lines 55-58), then append, update, or remove statements are used, respectively. The user-generated code performs the creation, updating, and deletion of independent entity sequence employee. The compiler-generated code performs the creation, updating, and deletion of the computed entity, as described below.

The compiler auto-generates the code for Memory Model 3 shown in Example 7.

| | |
|---|---|
| A | // Model 3: Compiler Generated code |
| B | // Event handlers for Computed Entity ExpMlsSalary[ ] |
| C | @call(team.exp_mls_salary[ ]) |
| D | if(not?(exists?(team.exp_mls_salary[ ]))) |
| E | for_each(I, in: team.employee[ ]) |
| F | if(i.designation == “MLS” and? i.experience > 10 and? i.salary > 150000) |
| G | append(team.exp_mls_salary[ ], i.salary) |
| H | else |
| I | team.exp_mls_salary[ ] |
| J | |
| K | // Add or delete employee or update employee salary |
| L | @create(employee) |
| M | if(exists?(team.exp_mls_salary[ ]) and? employee.designation == “MLS” and? employee.experience > |
| | 10 and? employee.salary > 150000) |
| N | append(team.exp_mls_salary[ ], employee.salary) |
| O | |
| P | @update(employee.salary) |
| Q | if(salary.employee.designation == “MLS” and? salary.employee.experience > 10 and? |
| | salary.employee.salary > 150000) |
| R | if(exists?(team.exp_mls_salary[ ]) and? (team.exp_mls_salary[ ].employee[ ].has?(salary.employee)) |
| S | replace(team.exp_mls_salary[ ], salary) |
| T | else_if(exists?(team.exp_mls_salary[ ])) |
| U | append(team.exp_mls_salary[ ], salary) |
| V | |
| W | else_if((exists?(team.exp_mls_salary[ ]) and ? |
| | team.exp_mls_salary[ ].employee[ ].has?(salary.employee)) |
| X | remove(team.exp_mls_salary[ ], index:team.exp_mls_salary[1] (exp_mls_salary.employee == |
| | salary.employee).index) |
| Y | |
| Z | |
| AA | @delete(employee) |
| AB | if(exists?(team.exp_mls_salary[ ]) and? employee.designation == “MLS” and? employee.experience > 10 |
| | and? employee.salary > 150000) |
| AC | if(team.exp_mls_salary[ ].count == 1) #last element in sequence, so deleting entire sequence |
| AD | delete(team.exp_mls_salary[ ]) |
| AE | else |
| AF | remove |
| AG | team.exp_mls_salary[ ] |
| AH | element: team.exp_mls_salary[1](employee == exp_mls_salary.employee) |
| | // Event handlers for Computed Entity ExpMtsSalary[ ] |
| AI | @call(team.exp_mts_salary[ ]) |
| AJ | if(not?(exists?(team.exp_mts_salary[ ]))) |
| AK | for_each(I, in: team.employee[ ]) |
| AL | if(i.designation == “MTS” and? i.experience > 10 and? i.salary > 50000) |
| AM | append(team.exp_mts_salary[ ], i.salary) |
| AN | else |
| AO | team.exp_mts_salary[ ] |
| AP | |
| AQ | //updating to Employee |
| AR | @create(employee)//@update of employee [ ], new employee added and/or deleted |
| AS | if(exists?(team.exp_mts_salary[ ]) and? employee.designation == “MTS” and? employee.experience > |
| | 10 and? employee.salary > 50000) |
| AT | append(team.exp_mts_salary[ ], employee.salary) |
| AU | |
| AV | @update(employee.salary) |
| AW | if(salary.employee.designation == “MTS” and? salary.employee.experience > 10 and? |
| | salary.employee.salary > 50000) |
| AX | if(exists?(team.exp_mts_salary[ ]) and? team.exp_mts_salary[ ].employee[ ].has?(salary.employee)) |
| AY | replace(team.exp_mts_salary[ ], salary) |
| AZ | else_if(exists?(team.exp_mts_salary[ ]) ) |
| BA | append(team.exp_mts_salary[ ], salary) |
| B | |
| BC | else_if(exists?(team.exp_mts_salary[ ]) and? |
| | team.exp_mts_salary[ ].employee[ ].has?(salary.employee)) |
| BD | remove(team.exp_mts_salary[ ], index: team.exp_mts_salary[1](exp_mts_salary.employee == |
| | salary.employee).index) |
| BE | |
| BF | |
| BG | @delete(employee) |
| BH | if(exists?(team.exp_mts_salary[ ]) and? employee.designation == “MLS” and? employee.experience > |
| | 10 and? employee.salary > 150000) |
| BI | if(team.exp_mts_salary[ ].count == 1) #last element in sequence, so deleting entire sequence |
| BJ | delete(team.exp_mts_salary[ ]) |
| BK | else |
| BL | remove |
| BM | team.exp_mts_salary[ ] |
| BN | element: team.exp_mts_salary[1](employee == exp_mts_salary.employee) |

### Example 7. Illustrative Compiler-Generated Pseudocode for Memory Model 3

Creation of the computed entity sequence: @call (team.exp_mls_salary) (line C) is triggered when computing the TeamMlsCost expression (line 18) for the mapped entity. When there is a demand for the computed entity exp_mls_salary (from the developer code lines 23-26), then creation of the computed entity occurs (from the compiler generated code). A check for the computed entity existing is made (line D). If it does not exist, then computed entity ExpMlsSalary is created by looping through every employee in the team and each employee with designation MLS, salary greater than Rs 150,000, and experience greater than 10 years is appended to the exp_mls_salary sequence (lines E through G). If the CE already exists it is simply returned (lines H-I). In memory model 3, the computed entity, once created, will remain until the independent entity on which it depends is deleted. This @call event handler is an example of a CE1 Create event handler 750 described above with respect to FIG. 7D.

Lines K-X show compiler-generated code for responding to an update of independent entity Employee. Recall that with memory model 3, the computed entity is not updated unless it has already been created at its first on-demand access. Updating the computed entity sequence can be an addition of a new element to the sequence, updating the field of an element in the sequence, or removing the element from the sequence. An addition of a new element, for example an employee (line 42), invokes lines L-N where the new employee is appended to the exp_mls_salary sequence (if it is existing at the time). If an employee's field such as salary is to be updated (line 50), then the update statement performs this operation by invoking the lines P-X of the compiler generated code, where the salary field of an employee is updated with the new value in the exp_mls_salary sequence. If an employee is to be removed from the organization (line 55), lines AA-AH are invoked where the employee is deleted from the exp_mls_salary sequence. These @create, @update, and @delete event handlers together form an example of CE Update event handler 770 detailed above with respect to FIG. 7D.

Event handlers for computed entity ExpMtsSalary [ ] are also generated as shown in line AG to BN in Example 7. A call to create that CE will have been placed appropriately during code generation prior to an access statement for the CE (details not shown). In this example, at runtime, since the ExpMtsSalary [ ] CE has not yet been created, the update of the independent entity does not invoke an update to the computed entity exp_mts_salary [ ]. If additional instructions are included (not shown) that access the second CE, it will be created. Henceforth an update to the independent entity will cause a call to update both CEs described in this example.

In this example, a parse tree equivalent to the compiler generated code is stitched to the original parse tree generated by the compiler for the user code. The code generation phase adds a call to these events at appropriate locations of the final executable code generated by the compiler. An example is described above with respect to FIG. 7D.

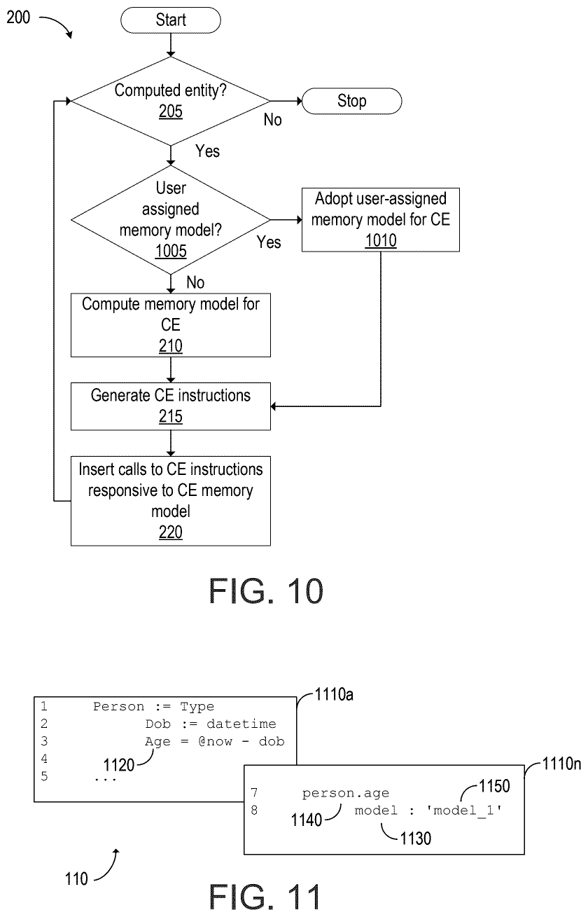

FIG. 10 is an alternate flowchart 200 illustrating a method of low-level memory management for computed entities supporting user assigned memory models. The process works as detailed above for FIGS. 2A-D, except that when a computed entity is encountered (205) the compiler checks to see if a user-assigned memory model has been provided (1005). If not, the process continues as in FIG. 2A. If one has been supplied (1005) then the compiler adopts the user-assigned memory model for the CE (1010). Then the process generates CE instructions (215) and inserts calls to the CE instructions responsive to the user-assigned CE memory model (220). In this embodiment, the compiler does not compute or perform analysis to determine a memory model for a CE which has a user-assigned model. In other embodiments, it may be that the compiler performs analysis and/or selection for all CEs. In this case, the user-assigned memory model may override the compiler assigned memory model. For those computed entities not having user-assigned models, the compiler assigns the memory model based on analysis as detailed above. Alternate priorities of compiler assigned and user assigned models may be deployed in alternate embodiments.

FIG. 11 illustrates a construct for supporting user assigned memory models. The construct may be defined within a programming language, deployed in source code in one or more files, or a setting in a configuration file, or a combination. This selection of files is denoted 1110a-1110n in FIG. 11. Here, in the example pseudocode, a construct 1130, “model” in this embodiment, is associated with a CE 1140, and assigns one of the models available to the compiler with a model assignment modifier 1150. In this example, an entity may be ornamented, in which additional aspects for the entity may be defined. This is one example construct placement, where one ornamentation a user can specify is the model. Ornamentation may be done in the same file where the source code is present, or in separate files. In this example, element Age 1120 has been defined in type Person. The element, person.age 1140, is identified to be modified with the model construct 1130, and the model selected 1150 is ‘model_1’.

In the above example, lines 1 to 3 defines a type Person with an independent entity Dob in line 2 and a computed entity Age calculated using Dob in line 3. In lines 7 and 8, the user assigns a model to manage the creation by allocating memory and deleting by deallocating the memory of the computed entity. Here, the user can assign from a set of compiler supported models such as model_1, model_2 and model_3. Here “model” is assigned with any one of the three models supported by the compiler. The compiler supported models defined in this example are model_1, model_2, and model_3, which correspond to the respective Memory Models 1, 2, & 3, detailed above.

Source code, in one or more files, containing type definitions, container definitions, model indicators, and other constructs such as those detailed above may be stored on one or more non-transitory computer-readable media, and compilable by a compiler into one or more programs and executable by a processor. A system may be deployed comprising one or more processors coupled to a memory, wherein the one or more programs are stored in the memory and configured to be executed by the one or more processors, the one or more programs including program instructions that perform one or more of the various methods detailed above. An example system is detailed below with respect to FIG. 12.

A compiler, examples of which are described above, is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The prior discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art.

FIG. 12 illustrates an example embodiment of distributed Integrated Development Environment (IDE) 1200 including components of a computational device, or user terminal, 100. Here user terminal 100 is connected via network 1240 with other user terminals 100a-n and a project server 1250. However, it should be noted that an IDE operating environment, a computational device 100, and the aspects disclosed herein are not constrained to any particular configuration of devices.

User terminals 100 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 1200 may be configured in a network environment, a distributed environment, a multi-processor environment, or a stand-alone computing device having access to remote or local storage devices.

User terminals 100 may include one or more processors 1210, a communication interface 1212, one or more storage devices 1216, one or more input/output devices 1218, and a memory 150. A processor 1210 may be any commercially available or customized processor and may include multi-processor architectures. The communication interface 1212 facilitates wired or wireless communications between the computing devices such as user terminals 100, project server 1250, and other devices. The components of a user terminal 100 are communicatively coupled via one or more buses 1214.

A storage device 1216 may be a computer-readable medium that does not contain propagating signals, such as modulated data signals transmitted through a carrier wave. Examples of a storage device 1216 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1216 in the computing devices 100. The input/output devices 1218 may include a keyboard, mouse, pen, voice input device, touch input device, display, speakers, printers, etc., and any combination thereof.

A memory 150 may be any non-transitory computer-readable storage media that may store executable procedures, applications, and data. Various of these components and data are detailed above with respect to FIGS. 1, 4, and 6. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. A memory 150 may also include one or more external storage devices or remotely located storage devices.

The memory 150 may contain instructions, components, and data. A component is a software program that performs a specific function and is otherwise known as a module, program, and/or application. The memory 150 may include an operating system 1230, one or more source code files 110, a compiler 130, executable code 160, and other applications and data 1236. Compiler 130 may include a lexical analyzer 610, a syntax analyzer 615, a semantic analyzer 620, an intermediate code generation module 625, a code optimization module 630, a code generation module 185, a low-level memory management (LLMM) module 120, an abstract syntax tree 180, and an intermediate representation 140.

User terminal 100 may utilize an IDE (details not shown) that allows a user (e.g., developer, programmer, designer, coder, etc.) to design, code, compile, test, run, edit, debug, or build a program, set of programs, web sites, web applications, and web services in a computer system. Software programs can include source code files 110, created in one or more source code languages (e.g., Visual Basic, Visual J #, C++. C #, J #, Java Script, APL, COBOL, Pascal, Eiffel, Haskell, ML, Oberon, Perl, Python, Scheme, Smalltalk and the like, as well as proprietary or custom-designed programming languages). The IDE may provide a native code development environment or may provide a managed code development that runs on a virtual machine or may provide a combination thereof. The IDE may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

Project server 1250 may be any type of electronic device, including without limitation those detailed for user terminals 100. A project server may be configured utilizing a cloud service.

The user terminals 100 and project server 1250 may be communicatively coupled via network 1240. The network 1240 may be configured as an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Network (MAN), the Internet, a portion of the Public Switched Telephone Network (PSTN), Plain Old Telephone Service (POTS) network, a wireless network, a WiFi® network, or any other type of network or combination of networks.

The network 1240 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112 (f).

1. A method of compiling a program representation, the program representation having:
an independent entity;
a computed entity, computed using the independent entity;
a first statement with instructions affecting at least the computed entity; and
a second statement with instructions affecting at least the independent entity; the method comprising:
generating first instructions from the first statement which compile to runtime first instructions;
generating second instructions from the second statement which compile to runtime second instructions;
computing a cost for the computed entity;
selecting one of a plurality of memory models responsive to the computed cost;
responsive to selecting a first of the memory models, inserting the first instructions into the program representation such that the runtime first instructions are executed in a first manner relative to the runtime second instructions at runtime; and
responsive to selecting a second of the memory models, inserting the first instructions into the program representation such that the runtime first instructions are executed in a second manner relative to the runtime second instructions at runtime.

2. The method of claim 1, wherein:
responsive to selecting the first of the memory models, the first instructions are inserted into the program representation such that the runtime first instructions are executed in a sequence coupled with the runtime second instructions at runtime; and
responsive to selecting the second of the memory models, the first instructions are inserted into the program representation such that the runtime first instructions are executed in a sequence decoupled with the runtime second instructions at runtime.

3. The method of claim 2, wherein the program representation further comprises a third statement with instructions affecting at least the computed entity, the method further comprising:
generating third instructions from the third statement which compile to runtime third instructions; and
responsive to selecting the second of the memory models, inserting the first instructions into the program representation such that the runtime first instructions are executed in a sequence coupled with the runtime third instructions at runtime.

4. The method of claim 2 wherein the first instructions allocate memory for the computed entity and the second instructions create the independent entity.

5. The method of claim 2, wherein the second instructions update the independent entity and the first instructions recompute the computed entity.

6. The method of claim 5, wherein the first instructions validate the computed entity and conditionally recompute the computed entity when the computed entity is invalid.

7. The method of claim 6, wherein the validation comprises comparing a computed entity time with an independent entity time.

8. The method of claim 2, wherein the second instructions delete at least the independent entity and the first instructions deallocate memory for the computed entity.

9. The method of claim 3, wherein the third instructions access the computed entity.

10. The method of claim 9, further comprising determining a usage termination point at which instructions in the program representation, when compiled and executed at runtime, no longer access the computed entity subsequent to the runtime third instructions.

11. The method of claim 2, further comprising generating fourth instructions to check for the existence of the computed entity at runtime and to conditionally execute the first instructions responsive to the computed entity not existing.

12. The method of claim 3, further comprising generating fourth instructions to check for the existence of the computed entity at runtime and to conditionally execute the first instructions responsive to the computed entity not existing.

13. The method of claim 1, wherein the program representation further comprises an access statement for accessing the computed entity, the method further comprising:
generating access instructions from the access statement which compile to runtime access instructions; and
responsive to selecting the second memory model, the first instructions are inserted into the program representation such that the runtime first instructions are executed in a sequence prior to and coupled with the runtime access instructions at runtime.

14. The method of claim 13, further comprising:
determining a usage termination point at which instructions in the program representation executed in a sequence subsequent to the runtime access instructions no longer access the computed entity for a period of time;
generating third instructions to deallocate the memory for the computed entity which compile to third runtime instructions; and
responsive to selecting the second memory model, inserting the third instructions into the program representation such that the third runtime instructions are executed in a sequence subsequent to and coupled with a location associated with the usage termination point at runtime.

15. The method of claim 1, wherein the program representation further comprises a delete statement for deleting the independent entity, the method further comprising:
generating delete instructions from the delete statement which compile to runtime delete instructions;
generating third instructions to deallocate the memory for the computed entity which compile to third runtime instructions; and
responsive to selecting the first memory model, inserting the third instructions into the program representation such that the third runtime instructions are executed in a sequence coupled with the runtime delete instructions at runtime.

16. The method of claim 1, wherein the program representation further comprises a delete statement for deleting the independent entity, the method further comprising:
generating delete instructions from the delete statement which compile to runtime delete instructions;
generating third instructions to deallocate the memory for the computed entity which compile to second runtime instructions; and
responsive to selecting the second memory model, inserting the third instructions into the program representation such that the third runtime instructions are executed in a sequence coupled with the runtime delete instructions at runtime.

17. The method of claim 1, wherein the program representation further comprises a delete statement for deleting the independent entity, the method further comprising:
generating delete instructions from the delete statement which compile to runtime delete instructions;
generating third instructions to deallocate the memory for the computed entity which compile to third runtime instructions; and
responsive to selecting the second memory model, inserting the third instructions into the program representation such that the third runtime instructions are executed in a sequence decoupled with the runtime delete instructions at runtime.

18. The method of claim 1, wherein the program representation further comprises an update statement modifying the independent entity, the method further comprising:
generating update instructions from the update statement which compile to runtime update instructions;
generating third instructions to compute the computed entity which compile to runtime third instructions; and
inserting the third instructions into the program representation such that the runtime third instructions are executed in a sequence coupled with the runtime update instructions at runtime.

19. The method of claim 1, wherein the program representation further comprises an update statement modifying the independent entity, the method further comprising:
generating update instructions from the update statement which compile to runtime update instructions;
generating third instructions to compute the computed entity which compile to runtime third instructions; and
inserting the third instructions into the program representation such that the runtime third instructions are executed in a sequence decoupled with the runtime update instructions at runtime.

20. The method of claim 1, wherein the program representation further comprises an update statement modifying the independent entity, the method further comprising:
generating update instructions from the update statement which compile to runtime update instructions;
generating third instructions to compute the computed entity which compile to runtime third instructions;
generating fourth instructions to determine whether the computed entity exists in memory at runtime and to call the runtime third instructions responsive to the computed entity existing at runtime, the fourth instructions which compile to runtime fourth instructions; and
inserting the fourth instructions into the program representation such that the runtime fourth instructions are executed in a sequence coupled with the runtime update instructions at runtime.

21. The method of claim 1, wherein the program representation further comprises an update statement modifying the independent entity, the method further comprising:
generating update instructions from the update statement which compile to runtime update instructions;
generating third instructions to compute the computed entity which compile to runtime third instructions;
generating fourth instructions to determine whether the computed entity exists in memory at runtime and to call the runtime third instructions responsive to the computed entity existing at runtime, the fourth instructions which compile to runtime fourth instructions; and
inserting the fourth instructions into the program representation such that the runtime fourth instructions are executed in a sequence decoupled with the runtime update instructions at runtime.

22. The method of claim 1, wherein the program representation comprises a source code in a high-level programming language.

23. The method of claim 1, wherein the program representation comprises an intermediate representation.

24. The method of claim 1, wherein the program representation comprises an abstract syntax tree.

25. The method of claim 1, wherein the program representation comprises LLVM intermediate representation.

26. The method of claim 1, wherein the program representation comprises machine code.

27. The method of claim 1, wherein:
the first instructions comprise:
an event handler; and
a call to the event handler;
the call to the event handler is placed in a first location in the program representation responsive to selecting the first memory model; and
the call to the event handler is placed in a second location in the program representation responsive to selecting the second memory model.

28. The method of claim 27, wherein the first instructions are generated in source code format and are inserted into the program representation, the program representation being in source code format.

29. The method of claim 27, wherein the first instructions are inserted into the program representation during a semantic analysis phase of compiling.

30. The method of claim 27, wherein the event handler is inserted into the program representation during a semantic analysis phase of compiling; and
the call to the event handler is inserted into the program representation in a code generation phase of compiling.

31. The method of claim 1, wherein the computing a cost comprises computing a memory cost.

32. The method of claim 1, wherein the computing a cost comprises computing a computational cost.

33. The method of claim 1, wherein the second statement further comprises instantiating a data object of a data type comprising the independent entity.

34. The method of claim 1, wherein the independent entity and the computed entity belong to different types.

35. The method of claim 1, wherein the different types are related to each other.

36. (canceled)

37. A method of compiling a program representation, the program representation having:
an independent entity;
a computed entity, computed using the independent entity;
the method comprising:
encountering a statement accessing the computed entity which compiles to runtime access instructions;
generating delete instructions which compile to runtime delete instructions to delete the computed entity at runtime;
determining a usage termination point at which instructions in the program representation, when compiled and executed at runtime, no longer access the computed entity subsequent to the runtime access instructions; and
inserting the delete instructions into the program representation such that the runtime delete instructions are executed in a sequence subsequent to and coupled with a location associated with the usage termination point at runtime.

38. The method of claim 37, wherein the usage termination point is determined when the computed entity is no longer accessed for a subsequent period of time.

39. The method of claim 37, wherein the usage termination point is determined when a function comprising the statement accessing the computed entity terminates.

40. The method of claim 37, wherein the usage termination point is determined when program execution exits a scope.

41. The method of claim 37, wherein the usage termination point is determined when the independent entity is deleted.

42. The method of claim 37, the program representation further comprising an update statement to update the independent entity, the method further comprising:
generating first instructions to update the independent entity which compile to first runtime update instructions to update the independent entity at runtime;
generating second instructions to update the computed entity which compile to second runtime update instructions to update the computed entity at runtime; and
inserting the first instructions into the program representation such that the second runtime instructions are executed in a sequence subsequent to and coupled with the first runtime update instructions at runtime.

43. The method of claim 37 further comprising:
encountering a second statement accessing the computed entity which compiles to second runtime access instructions;
generating instructions to update the computed entity which compile to runtime update instructions to update the computed entity at runtime; and
inserting the instructions to update the computed entity into the program representation such that the runtime update instructions are executed in a sequence subsequent to and coupled with the second runtime access instructions at runtime.

44.-60. (canceled)

61. A system comprising:
one or more processors coupled to a memory; and
one or more programs, wherein the one or more programs are stored in the memory and configured to be executed by the one or more processors, operable with source code having:
a data type defining a data object, the data type having:
an independent entity; and
a computed entity, computed using the independent entity; and
a create statement for instantiating the independent entity,
the one or more programs including program instructions that:
generate create instructions from the create statement which compile to runtime create instructions;
generate first instructions to allocate memory for the computed entity which compile to runtime first instructions;
compute a cost for the computed entity;
select one of a plurality of memory models responsive to the computed cost;
responsive to selecting a first of the memory models, insert the first instructions into an intermediate representation such that the runtime first instructions are executed in a sequence coupled with the runtime create instructions at runtime; and
responsive to selecting a second of the memory models, insert the first instructions into the intermediate representation such that the runtime first instructions are executed in a sequence decoupled with the runtime create instructions at runtime.

62. (canceled)
